(19) United States
(12) Patent Application Publication
(10) Pub. No.: US 2025/0278955 A1
(43) Pub. Date: Sep. 4, 2025

(54) DATABASE FOR IDENTIFYING DECEASED RELATIVES

(71) Applicant: Ancestry.com Operations Inc., Lehi, UT (US)

(72) Inventors: Samuel Fischer, San Francisco, CA (US); Mariah Krimchansky, San Francisco, CA (US); Bryce Damon Ririe, Highland, UT (US); Jeff Day, Payson, UT (US); Spencer Orval Killian, Lindon, UT (US); Seth Schreiberg, Oakland, CA (US); John Egbert, Orem, UT (US); Douglas Garry Earl, Orem, UT (US); Lucy Johnston, Somerville, MA (US)

(21) Appl. No.: 19/065,954

(22) Filed: Feb. 27, 2025

Related U.S. Application Data
(60) Provisional application No. 63/559,767, filed on Feb. 29, 2024.

(51) Int. Cl. G06V 40/16; G06F 16/55; G06V 10/26; G06V 10/74; G06V 10/762; G06V 20/70

(52) U.S. Cl. CPC G06V 40/172; G06F 16/55; G06V 10/26; G06V 10/761; G06V 10/7625; G06V 20/70; G06V 40/161

(57) ABSTRACT

A computer-implemented method for identifying an ancestor comprises segmenting a face image from an image associated with a user, providing the segmented face image to an ancestor-recognition cluster database, identifying a cluster of the ancestor-recognition cluster database comprising an image matching the segmented face image, and outputting media form the identified cluster to the user. The images may be determined to match using a suitable facial-recognition modality. Face images are compared to images corresponding to clusters that are determined to represent deceased individuals. The clusters are determined to represent deceased individuals by assessing the metadata and/or contents of the cluster to evaluate confidence that a death event has occurred.

### CROSS-REFERENCE TO RELATED APPLICATIONS

The present application claims priority to, and the benefit of, U.S. Provisional Application No. 63/559,767, titled DATABASE FOR IDENTIFYING DECEASED ANCESTORS, filed on Feb. 29, 2024. The aforementioned application is hereby incorporated by reference in its entirety.

### FIELD

The disclosed embodiments relate to systems, methods, and/or computer-program products configured for generating a specialized database configured for identifying deceased relatives such as ancestors, and more particularly to configuring a genealogical database to confidently identify database clusters associated with deceased persons for identification thereof from images.

### BACKGROUND

A large-scale database such as a user profile, genealogy, and genetic database can include billions of data records (i.e., genealogical content items). This type of database may allow users to build family trees, research their family history, and make meaningful discoveries about the lives of their relatives, such as their ancestors. Users may try to identify relatives with datasets in the database. However, identifying all extant records, instances, and images of a relative in a database comprising tens of billions of records and tens of millions of monthly active users, most of which users have built their own pedigrees with associated data such as records and images, is not a trivial task; in fact, it is impossible for unaided users to positively identify all possible records, images, and genealogical-tree instances of an ancestor given that distant relatives may have uploaded, identified, or otherwise researched such instances in parallel unbeknownst to the user or indeed without the users even being aware that they are relatives. Similarly, images, records, or other valuable data pertaining to an ancestor may be found in a record collection, such as a yearbook collection, that an interested user may not be aware of and may not find during a search.

There is further a challenge of identifying instances of a relative from previously unindexed and/or unidentified instances, such as images uploaded by a user where not all persons in the image are known. In many cases, a user may have received family photos showing individuals that they are not familiar with, and that there are no longer living relatives who are able to identify. For such users, identifying these individuals is no longer feasible, with that link in their family tree being forever severed. Further, descendants of these unknown individuals are deprived the opportunity to find these images and associated nodes, records, and other data given that the images are unable to be tied, by a user and/or by a genealogical database utility, to a pertinent node or cluster.

Indeed, while some existing systems may be able to detect faces in images, such systems are unable to leverage the detection for further identification and/or relationship information of individuals. Moreover, some prior systems utilize batch processing (e.g., periodic updates of databases), such as once every six months, thus limiting the accuracy of information that goes out of date and becomes obsolete over intervening periods. Such inaccurate data compromises the efficacy of downstream processes as well, preventing reliable relationship predictions, index updates, or other uses of out-of-date data. Given that a potentially interested user may not continue to use the genealogical research service over such a duration that would allow them to receive the benefit of a periodic update, many users are thus deprived of the opportunity to be connected to a relative through a more-frequent update.

In view of the foregoing, there is a need for improved approaches for connecting interested users with otherwise unknown data pertaining to their relatives, including identifying ancestors.

### SUMMARY

This disclosure describes one or more embodiments of systems, methods, and non-transitory computer-readable storage media that provide benefits and/or solve one or more of the foregoing and other problems in the art. For instance, the disclosed systems utilize image-segmentation approaches in conjunction with genealogical-data analysis to identify individuals depicted in images for comparison with a face-image index. For example, the disclosed systems segment a digital image to detect or recognize a depicted face. In addition, the disclosed systems can compare the detected face with a face-image index to identify a matching image depicting the same face as detected in the segmented image. In one or more embodiments, the disclosed systems further identify a matching cluster of genealogical data in a specialized ancestor-recognition cluster database corresponding to an individual depicted in the matching image and the segmented image. In some embodiments, the disclosed systems can provide matching notifications and modify genealogical trees according to the matching cluster.

### BRIEF DESCRIPTION OF THE DRAWINGS

The disclosure describes one or more embodiments of the invention with additional specificity and detail by referencing the accompanying figures. The following paragraphs briefly describe those figures.

FIG. 1 illustrates a schematic diagram of an example system environment for implementing an ancestor-identification system in accordance with one or more embodiments.

FIG. 2 illustrates an overview of utilizing a face-image index and an ancestor-recognition to identify an individual depicted in an image in accordance with one or more embodiments.

FIG. 3 illustrates generating or otherwise modifying a cluster of nodes responsive to identifying an individual in accordance with one or more embodiments.

FIGS. 4A-4D illustrate exemplary user interfaces generated by the ancestor-identification system in accordance with one or more embodiments.

FIGS. 5A-5B illustrate exemplary genealogy trees generated and modified by the ancestor-identification system in accordance with one or more embodiments.

FIG. 6 illustrates an exemplary face-match notification generated by the ancestor-identification system in accordance with one or more embodiments.

FIG. 7 illustrates a genealogical entity-resolution system utilized by the ancestor-identification system in accordance with one or more embodiments.

FIG. 8 illustrates an example series of acts for generating a face-match notification in accordance with one or more embodiments.

FIG. 9 illustrates an example series of acts for identifying a cluster comprising an image that matches a segmented face in accordance with one or more embodiments.

FIG. 10 illustrates an exemplary computing system in accordance with one or more embodiments.

FIG. 11 illustrates an exemplary computing environment in accordance with one or more embodiments.

The drawing figures are not necessarily drawn to scale, but instead are drawn to provide a better understanding of the components, and are not intended to be limiting in scope, but to provide exemplary illustrations. The drawing figures, which are included to provide a further understanding of the disclosure, are incorporated in and constitute a part of this specification, illustrate embodiments of the disclosure and together with the detailed description serve to explain the principles of the disclosure.

No attempt is made to show structural details of the disclosure in more detail than may be necessary for a fundamental understanding of the disclosure and various ways in which it may be practiced. The figures illustrate exemplary configurations of systems and methods for ancestor identification, and in no way limit the structures, configurations, or functions of systems and methods for ancestor identification, and components thereof, according to the present disclosure.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### A. Introduction

Although the embodiments of the disclosure are adapted for providing systems and methods for ancestor identification, it will be appreciated that the principles of the disclosure may be adapted to any suitable application, such as historical, genealogical, and/or genetic research, exploration, organization, and/or visualization.

In the following description, various examples will be described. For purposes of explanation, specific configurations and details are set forth in order to provide a thorough understanding of the examples. However, it will also be apparent to one skilled in the art that the example may be practiced without the specific details. Furthermore, well-known features may be omitted or simplified in order not to obscure the embodiments being described.

A better understanding of different embodiments of the disclosure may be had from the following description read with the accompanying drawings in which like reference characters refer to like elements. While the disclosure is susceptible to various modifications and alternative constructions, certain illustrative embodiments are in the drawings and are described below. It should be understood, however, there is no intention to limit the disclosure to the embodiments disclosed, but on the contrary, the intention is to cover all modifications, alternative constructions, combinations, and equivalents falling within the spirit and scope of the disclosure. Unless a term is defined in this disclosure to possess a described meaning, there is no intent to limit the meaning of such term, either expressly or indirectly, beyond its plain or ordinary meaning.

Reference characters are provided in the claims for explanatory purposes only and are not intended to limit the scope of the claims or restrict each claim limitation to the element in the drawings and identified by the reference character.

For ease of understanding the disclosed embodiments of systems and methods for ancestor identification, certain modules and features are described independently. The modules and features may be synergistically combined in embodiments to provide an ancestor-identification system, method, and/or computer-program product.

The figures (FIGS.) and the following description relate to preferred embodiments by way of illustration only. One of skill in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed ancestor-identification systems (or methods) for purposes of illustration only. One skilled in the art will readily recognize from the following description that alternative embodiments of the structures and methods illustrated herein may be employed without departing from the principles described herein.

### B. Embodiments of Ancestor-Identification Systems and Methods

Embodiments of ancestor-identification systems and methods address shortcomings in the art by facilitating the automated identification of relative, such as ancestors, of a user of a genealogical database. In embodiments, the genealogical database is modified to generate an index of deceased persons. The deceased-person index can be accessed to identify ancestors of a user from, e.g., a family photo. The deceased-person index may advantageously be generated as a catalog of confirmed deceased individuals, with associated images, for fast comparison against images of unknown persons. This advantageously facilitates reduction of processing-resource requirements and reduced latency, and accordingly, lower costs and improved user engagement. In embodiments, the genealogical database comprises an ancestor-recognition cluster database which is modified to identify clusters corresponding to deceased persons. In embodiments, the deceased-person index recreates an ancestor-recognition cluster database of the genealogical database while restricting the nodes that are incorporated into the clusters, and/or the clusters that are incorporated into the database, to persons confirmed as deceased.

Moreover, embodiments of the ancestor-identification system demonstrate improved accuracy compared to prior systems. Indeed, by generating and updating a face-image index and then utilizing the face-image index to determine digital images matching (e.g., reflecting the same individual as) a source digital image, the ancestor-identification system can accurately update databases (e.g., databases storing clusters of data records and/or genealogy trees) to link images to nodes or individuals. The ancestor-identification system can also generate more accurate, reliable matches to nodes or individuals (for updating databases) as a result of indexing more frequently compared to conventional systems that rely on batch updates.

In addition, embodiments of the ancestor-identification system improve navigational efficiency compared to conventional systems as well. For example, rather than requiring user accounts to repetitively navigate through genealogy trees and image databases (containing millions or billions of images) to locate images depicting individuals and then to add and/or modify tree nodes to include located images, the ancestor-identification system can automatedly identify images depicting individuals and can modify (automatedly or via providing prompts in a user interface and receiving user selections therefrom) genealogy trees to include or associate identified images. Moreover, in some embodiments, the ancestor-identification system can even automatedly generate and add tree nodes to a genealogy tree of a user account to link a node of the user account to a node corresponding to a target individual depicted in an identified image. Likewise, the ancestor-identification system can generate and/or update (automatedly or via providing prompts in a user interface) clusters in an ancestor-recognition cluster database to include images depicting identified individuals. This advantageously facilitates the generation of hints that users can access, review, and act on, e.g. by saving the hint—such as an image in which a deceased ancestor has been automatedly identified using the disclosed embodiments—to a pertinent node of a genealogical pedigree or by adding a pertinent node to a genealogical pedigree. This improves user engagement with a genealogical research service and facilitates successful and emotionally engaging and fulfilling genealogical and/or historical research by the user.

In some embodiments embodiment, a user of a genealogical research service (or the ancestor-identification system) may access via a user interface thereof an image through, e.g., a hint notification, a record or image search, by viewing a profile and associated image gallery, by digitizing/uploading a family photo, or by any other suitable method. Such image may include one or more person, one of which may not be familiar to the user. The one or more persons may be identified using suitable face-detection modalities such that a user may select a generated bounding box associated with the unfamiliar person to indicate that said person is unfamiliar and/or to otherwise request identification of the person. This may include, in embodiments, providing a selectable option indicating that they consent to the use of artificial-intelligence modalities including facial recognition to identify the individual. In some embodiments, the user may be presented, through the user interface, an option for confirming that they understand the unfamiliar person to be deceased.

The genealogical research service (or the ancestor-identification system) may segment the image such that only the portion(s) of the image corresponding to the selected unfamiliar person remains. The segmented image corresponding to the selected unfamiliar person may be compared against the deceased-person index and/or a modified genealogical ancestor-recognition cluster database using suitable facial-recognition modalities, such as Amazon Rekognition, available from Amazon.com, Inc., of Bellevue, WA, or a native face-detection tool available from Apple Inc. of Cupertino, CA or Google LLC of Menlo Park, CA. While Amazon Rekognition or native face-detection tools of Apple or Google have been described, it will be appreciated that the disclosure is not limited thereto, but rather any suitable facial-recognition modality may be used. The segmented and face-recognized image may be attached to or associated with a node of a genealogical tree database and/or an ancestor-recognition cluster database based on a detected match between existing image(s) or other data associated with the node. The attachment to and/or association with the node may be based on a similarity score determined between the images exceeding a predefined threshold. The generation of a similarity score may be generated using the facial-recognition modality mentioned above or using any other suitable modality. Matches identified in the deceased-person index may be retrieved from an ancestor-recognition cluster database of the genealogical research service.

In embodiments, the segmented and face-recognized image may be used to identify a particular tree node and then identify cluster(s) of the ancestor-recognition cluster database that that tree node is a part of. A “non-living” or “deceased” score may be generated for individual nodes and/or clusters. In embodiments, the non-living score for a cluster is determined as a function of two or more different tree nodes of a cluster or clusters of the ancestor-recognition cluster database having (i) marked a node as deceased (e.g. comprising metadata for the node corresponding to a deceased person), or where cluster members have metadata indicating that a status of “living person” is false, such as where a check for a death date has returned positive, birth dates are greater than 100 years old, or other suitable calculations based on marriage and other events from parents, spouses, and children suggest the person corresponding to that node is deceased, where, in embodiments, a resulting score is a lower of the scores attached to or associated with the two tree nodes; (ii) a record source indicates a death event, where, in embodiments, a resulting score is the score of the record attached to or associated with the death event; (iii) a record source indicates a birth event that occurred greater than 100 years prior to the current date, where, in embodiments, a resulting score is the score of the record attached to or associated with the birth event; and/or (iv) a record source indicates a marriage and/or residence greater than 100 years prior to the current date, where, in embodiments, a resulting score is the score of the record attached to or associated with the marriage and/or residence event. It will be appreciated that the aforementioned factors are merely exemplary, and other approaches to determining that a cluster of the ancestor-recognition cluster database corresponds to a deceased person may be utilized as suitable.

In embodiments, where a node has a death date, extra weight is assigned for, e.g.: each year deceased in past; the count of tree nodes that have the death event; the count of records attached to the death event by users (e.g., through tree nodes); and/or the count of records attached to the death event by automatic stitching. In embodiments, where a node has a birth date greater than 100 years before the present date, extra weight is assigned for, e.g.: each year greater than 100; the count of tree nodes that have the birth event; the count of records attached to the birth event by users; and/or the count of records attached to the birth event by automatic stitching. In embodiments, where a node has marriage or residence events greater than 100 years before the present date, extra weight is assigned for, e.g.: each year greater than 100; the count of tree nodes that have the marriage or residence event; the count of records attached to the marriage or residence event by users; and/or the count of records attached to the marriage or residence event by automatic stitching.

In embodiments, a record source may be defined as a specific event being attached to a record, as opposed to being included in a cluster. A resulting (nonliving) score from the above heuristics may be compared against a predefined threshold for determining a deceased status of a tree person and/or cluster of an ancestor-recognition cluster database. In embodiments, a plurality of the above criteria may be assessed, with a highest resulting score selected for comparison against the predefined threshold. Where the resulting score exceeds the predefined threshold, the node and/or cluster associated with the uploaded and identified image may be determined to represent a deceased person and therefore suitable for positively identifying to a user and/or accordingly modifying an ancestor-recognition cluster database and/or tree database. In embodiments, the score may be generated based on all members of a cluster. In other embodiments, the score may be generated only on the basis of high-confidence cluster members. For example, cluster members may be filtered between high confidence and lower confidence members on the basis of a closeness of match between the cluster members. The closeness of a match between cluster members may be based on a comparison of names, events, dates, relatives, supporting records, and/or other factors as described in, e.g., U.S. Pat. No. 11,321,361, granted May 3, 2020. In embodiments, a threshold for determining that two nodes belong in a same cluster (as they correspond to a same individual) is raised to ensure that the determination that an individual is, in fact, deceased, highly trustworthy.

In embodiments, a representative member/individual of a cluster is identified. This representative individual may be chosen, e.g., on the basis of a number and/or quality of associated records and/or other details such as birth, marriage, death events and dates, relatives, etc., on the basis of a similarity between the representative individual's node and the other nodes in the cluster, or on any other basis. The representative member/individual of the cluster may be utilized as a base comparison against the identified image, and/or resources associated with the representative member/individual of the cluster, such as images, records, and associated family trees, may be made available to the user upon determination of a match.

As illustrated by the foregoing discussion, the present disclosure utilizes a variety of terms to describe features and benefits of the missing field system. Additional detail is hereafter provided regarding the meaning of these terms as used in this disclosure.

For example, as used herein, the term “machine learning model” refers to a computer algorithm or a collection of computer algorithms that automatically improve for a particular task through iterative outputs or predictions based on use of data. For example, a machine learning model can utilize one or more learning techniques to improve in accuracy and/or effectiveness. Example machine learning models include various types of neural networks, decision trees, support vector machines, and Bayesian networks. In some embodiments, the morphing interface system utilizes a large language machine learning model in the form of a neural network.

Relatedly, as used herein, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., confidence scores and/or face-match notifications) based on a plurality of inputs provided to the neural network. In some cases, a neural network refers to an algorithm (or set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a recurrent neural network (e.g., an LSTM), a graph neural network, a transformer neural network, or a generative adversarial neural network.

Additionally, as used herein, the term “target face” can refer to an image of a face for which an identification is requested. For example, a target face can be an image of a face for which a user or user account requests identification of an individual's name and/or relationship (e.g., where the ancestor-identification system determines if there is a genealogical relationship in a genealogy tree between the user account and an individual depicted in the target face).

Further, as used herein, the term “face-image index” can refer to a data construct (e.g., created for a database, such as a face image database or an ancestor-recognition cluster database) that can index or otherwise indicate database locations (of stored data) corresponding to individuals depicted in images. The face-image index can be a searchable construct including a plurality of labeled index elements that correspond to elements of a database. For example, the plurality of labeled index elements can be representations, such as vector representations, of digital images stored within a database. The face-image index can be updated (e.g., by the ancestor-identification system) as a database receives images (e.g., digital images and/or segmented digital images) along with a request to identify one or more individuals depicted in the image, such as a target face. The face-image index can be used to search images contained within a database. For example, face-image index can enable one or more image processing techniques (e.g., traditional image-processing techniques, deep-learning based techniques, hybrid approaches, among others) to be used to generate the plurality of labeled index elements. Further, the face-image index can facilitate determining a match (e.g., above a threshold similarity score) between the target face and faces depicted in images contained in the face-image index. In some embodiments, the face-image index can include a plurality of labeled index elements that correspond to images from an ancestor-recognition cluster database (e.g., images that have been determined to correspond to deceased individuals). The ancestor-identification system can utilize the face-image index to perform indexing of images in real time, such as, for example, when a source digital image is received by the ancestor-recognition cluster database and/or the ancestor-identification system. Further, in some embodiments, the face-image index can be a “deceased-person index” that can index or otherwise indicate database locations (of stored data) corresponding to deceased individuals depicted in images (e.g., the face-image index can be an index images of deceased individuals).

Additionally, as used herein, the term “ancestor-recognition cluster database” can refer to a database that comprises clusters comprising a plurality of instances of tree persons corresponding to deceased individuals that are clustered together on the basis of meeting a similarity threshold such that the tree-person instances are determined to correspond to a same person or individual. The ancestor-recognition cluster database may comprise or be configured to cooperate with a tree database. The tree database may comprise a plurality of user-generated or automatedly generated family trees comprising nodes representing individuals and comprising metadata and/or media associated therewith, and edges between the nodes, the edges representing relationships therebetween. The edges may comprise labels classifying the relationship, e.g. mother, father, sibling, spouse, child, etc. The ancestor-recognition cluster database may comprise clusters comprising a plurality of nodes from different trees (e.g. trees generated by different users) where the plurality of nodes have been determined based on a confidence score and/or threshold to correspond to a same individual on the basis of, e.g., the metadata and/or media associated with the nodes.

Moreover, as used herein, the term “matching cluster” can refer to a cluster within an ancestor-recognition cluster database that represents, or contains genealogical information (e.g., records) for an individual depicted in a digital image. Specifically, the individual of the matching cluster can be an identification of an individual corresponding to a target face. Accordingly, when the ancestor-identification system receives a request to identify a target individual, the ancestor-identification system can utilize a face-image index to search an ancestor-recognition cluster database to identify a matching cluster of an individual corresponding to the target face and output information of or relating to the matching cluster.

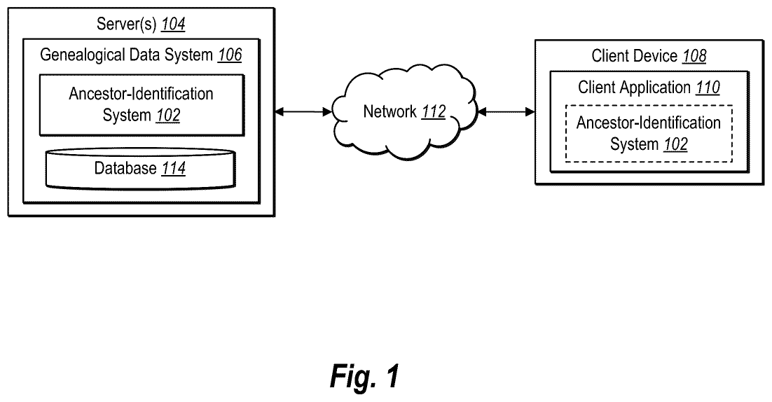

Additional detail regarding the ancestor-identification system will now be provided with reference to the figures. For example, FIG. 1 illustrates a schematic diagram of an example system environment for implementing an ancestor-identification system 102 in accordance with one or more implementations. An overview of the ancestor-identification system 102 is described in relation to FIG. 1. Thereafter, a more detailed description of the components and processes of the ancestor-identification system 102 is provided in relation to the subsequent figures.

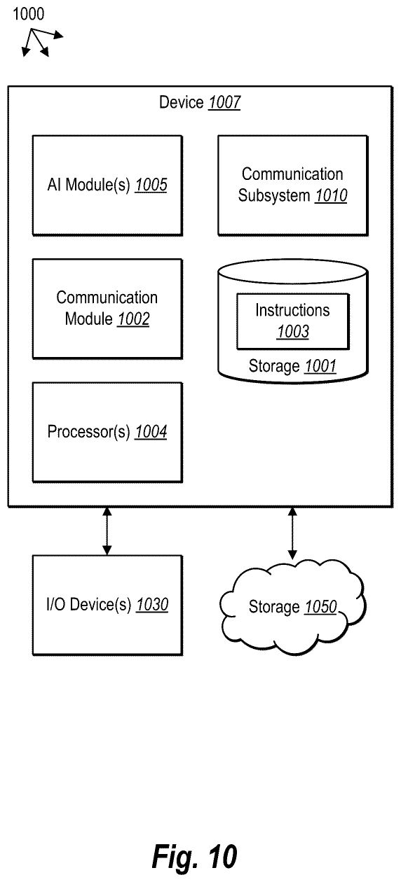

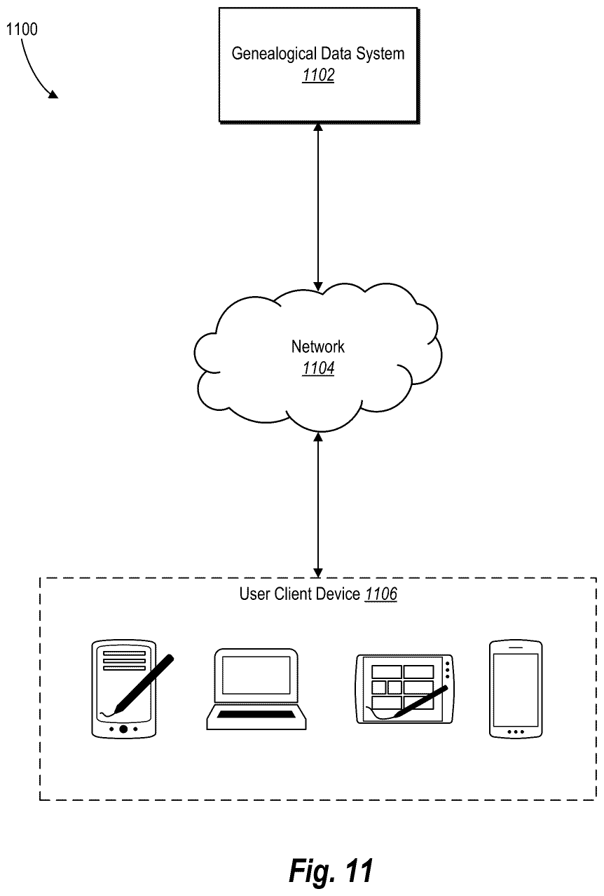

As shown, the environment includes server(s) 104, a client device 108, a database 114, and a network 112. Each of the components of the environment can communicate via the network 112, and the network 112 may be any suitable network over which computing devices can communicate. Example networks are discussed in more detail below in relation to FIGS. 10-11.

As mentioned above, the example environment includes a client device 108. The client device 108 can be one of a variety of computing devices, including a smartphone, a tablet, a smart television, a desktop computer, a laptop computer, a virtual reality device, an augmented reality device, or another computing device as described in relation to FIGS. 10-11. The client device 108 can communicate with the server(s) 104 and/or the database 114 via the network 112. For example, the client device 108 can receive user input from respective users interacting with the client device 108 (e.g., via the client application 110) to, for instance, search for, access, generate, modify, or share a genealogical content item (e.g., a data record) and/or to interact with a genealogy tree or a content item via a graphical user interface of the genealogical data system 106. In addition, the ancestor-identification system 102 on the server(s) 104 can receive information relating to various searches for, or interactions with, genealogical content items (e.g., data records), and/or user interface elements based on the input received by the client device 108.

As shown, the client device 108 can include a client application 110. In particular, the client application 110 may be a web application, a native application installed on the client device 108 (e.g., a mobile application, a desktop application, etc.), or a cloud-based application where all or part of the functionality is performed by the server(s) 104. Based on instructions from the client application 110, the client device 108 can present or display information, including a user interface such as a genealogical-content-item search interface, a genealogy tree interface, a discover interface for additional genealogical content, or some other graphical user interface, as described herein.

As illustrated in FIG. 1, the example environment also includes the server(s) 104. The server(s) 104 may generate, track, store, process, receive, and transmit electronic data, such as genealogical content items (e.g., data records), target faces, digital images, search queries, search results, and/or interactions with content items. For example, the server(s) 104 may receive data from the client device 108 in the form of a digital image (e.g., an upload or a selection from a repository of images), an indication of a selection to of a portion of a digital image, and/or to perform a search for a matching digital image. In addition, the server(s) 104 can transmit data to the client device 108 in the form of an image, a cluster of genealogical content items corresponding to an image, a search result corresponding to an image within a graphical user interface. Indeed, the server(s) 104 can communicate with the client device 108 to send and/or receive data via the network 112. In some implementations, the server(s) 104 comprise(s) a distributed server where the server(s) 104 include(s) a number of server devices distributed across the network 112 and located in different physical locations. The server(s) 104 can comprise one or more content servers, application servers, communication servers, web-hosting servers, machine learning server, and other types of servers.

As shown in FIG. 1, the server(s) 104 can also include the ancestor-identification system 102 as part of a genealogical data system 106. The genealogical data system 106 can communicate with the client device 108 to perform various functions associated with the client application 110 such as managing user accounts, managing genealogical data, managing genealogy trees, managing genealogical content items (e.g., data records), and facilitating user interaction with, and sharing of, the genealogy trees and/or genealogical content items. Indeed, the genealogical data system 106 can include a network-based cloud storage system to manage, store, and maintain genealogical content items and genealogy trees related data user accounts. For instance, the genealogical data system 106 can utilize genealogical data (stored in an ancestor-recognition cluster database and/or a tree database) across various content items and user accounts to generate and maintain a universal genealogy tree that reflects the relatedness or consanguinity between nodes corresponding to all user accounts and other individuals indicated by stored genealogical content items. In some embodiments, the ancestor-identification system 102 and/or the genealogical data system 106 utilize the database 114 (which includes or is made up of an ancestor-recognition cluster database and a tree database) to store and access information such as genealogical content items (e.g., data records), genealogy trees, clusters, user account data, and/or other information.

Although FIG. 1 depicts the ancestor-identification system 102 located on the server(s) 104, in some implementations, the ancestor-identification system 102 may be implemented by (e.g., located entirely or in part on) one or more other components of the environment. For example, the ancestor-identification system 102 may be implemented in whole or in part by the client device 108. For example, the client device 108 and/or a third-party system can download all or part of the ancestor-identification system 102 for implementation independent of, or together with, the server(s) 104.

In some implementations, though not illustrated in FIG. 1, the environment may have a different arrangement of components and/or may have a different number or set of components altogether. For example, the client device 108 may communicate directly with the ancestor-identification system 102, bypassing the network 112. As another example, the environment may include multiple client devices, each associated with a different user account. In addition, the environment can include the database 114 located external to the server(s) 104 (e.g., in communication via the network 112) or located on the server(s) 104 and/or on the client device 108.

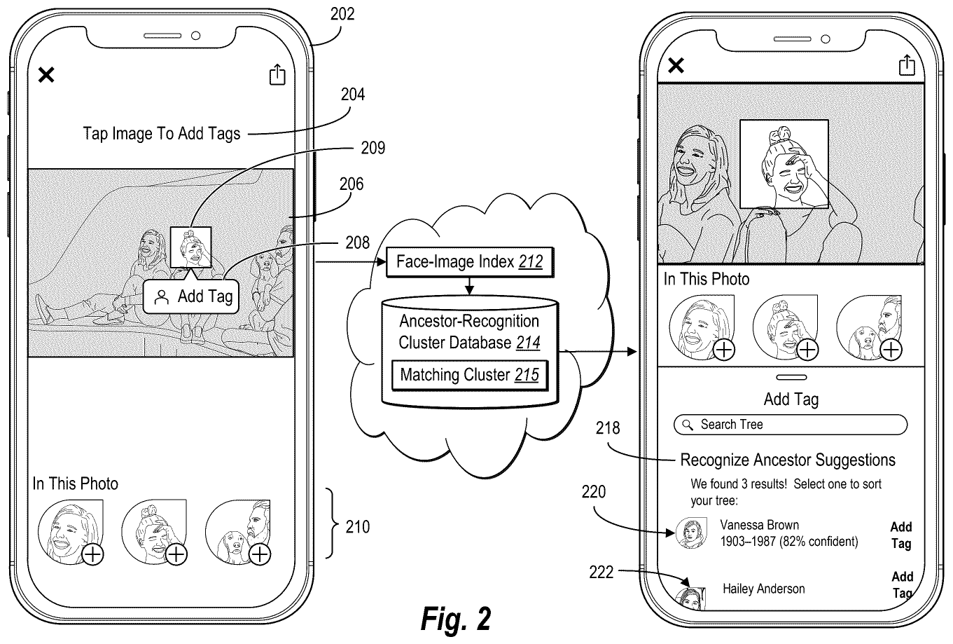

As previously mentioned, the ancestor-identification system 102 can utilize a face-image index and an ancestor-recognition cluster database to identify an individual depicted in a digital image. FIG. 2 illustrates an example overview of segmenting a source digital image to detect a target face and utilizing a face-image index and an ancestor-recognition cluster database to identify an individual depicted in the source digital image in accordance with one or more embodiments. Additional detail regarding the functions and processes introduced in relation to FIG. 2 is provided thereafter with reference to subsequent figures.

As shown in FIG. 2, the ancestor-identification system 102 can receive or identify a source digital image 206. Indeed, the ancestor-identification system 102 can receive the source digital image 206 from a client device 202, via an upload of the source digital image 206, such as from a photo library or some other repository, or via a selection from a repository of digital images (e.g., maintained by the genealogical data system 106 or located elsewhere). In some embodiments, the ancestor-identification system 102 can utilize the client device 202 (or another device) to scan an image to create the source digital image 206.

As illustrated in FIG. 2, the ancestor-identification system 102 can generate a prompt 204 for display on the client device 202 (e.g., through a user interface) requesting input from a user account (e.g., a tag for an individual depicted in the source digital image). In some embodiments, the ancestor-identification system 102 can determine an interaction with a tag option 208 of an individual depicted in the source digital image 206. The interaction with the tag option 208 can indicate an identified target face 209 (e.g., a target face identified by the client device or otherwise indicated by user account). For instance, the ancestor-identification system 102 receives a selection (e.g., a click of an identified face or a click-and-drag of an identified bounding box) of an area within the source digital image 206 that includes the identified target face 209.

Further, the ancestor-identification system 102 can segment the source digital image 206 to detect a face set 210 in the source digital image 206. The face set 210 can include the identified target face 209. In some embodiments, the ancestor-identification system 102 can automatically segment the source digital image 206 using a segmentation neural network to detect the face set 210. In some embodiments, the ancestor-identification system 102 can segment the source digital image 206 responsive to determining the interaction with the tag option 208 of the individual depicted in the source digital image 206.

As shown in FIG. 2, responsive to determining the identified target face 209 (or in response to a selection of the tag option 208), the ancestor-identification system 102 can generate a representation of the source digital image 206 (or a representation of a segment of the source digital image 206, or a representation of the target identified face 209). Further, the ancestor-identification system 102 can generate a face-image index 212 from the face set 210 and/or can add the face set 210 to the face-image index 212 that includes face data from previously indexed faces (e.g., from genealogical content items of the database 114). Indeed, the ancestor-identification system 102 searches the face-image index 212 which indexes faces identified from genealogical content items organized into clusters within the ancestor-recognition cluster database 214.

The ancestor-identification system 102 can use face-image index 212 to search for or otherwise determine a matching digital image depicting faces within a threshold similarity of the identified target face 209 (e.g., by searching the face-image index 212 to determine a labeled index element of a plurality of labeled index elements that matches the representation). The ancestor-identification system 102 can use the face-image index 212 to determine the matching digital image in real time or near real time (e.g., in interactive fashion responsive to selection of the tag option 208). Further, in some embodiments, the ancestor-identification system 102 can use the face-image index 212 to determine matching digital images for the face set 210 (e.g., faces other than the identified target face 209 depicted in the source digital image 206).

Further, in some embodiments, the ancestor-identification system 102 can identify an additional face from the source digital image 206 (e.g., from the face set 210). The ancestor-identification system 102 can analyze the face-image index 212 to determine an additional matching image that depicts a face of an additional individual that corresponds to the additional face. The ancestor-identification system 102 can utilize the additional matching image to identify an additional matching cluster of the ancestor-recognition cluster database 214 that corresponds to the additional individual depicted in the source digital image 206. Accordingly, the ancestor-identification system 102 can label the additional individual within the source digital image 206 to enable additional user accounts linked to the additional individual to search for the additional individual and/or for the genealogical research service to automatedly generate hints related to the additional individual on behalf of other users to whom the additional individual may be of genealogical-research interest.

Additionally, the ancestor-identification system 102 can account for one or more differences in a physical appearances of an individual caused by factors such as camera angle, camera nuances, lighting, resolution, aging, weight loss or gain, differences in hair style, among others. Accordingly, when analyzing the face-image index 212, the ancestor-identification system 102 can identify a face of an individual that corresponds to a face depicted in the source digital image 206. For example, the ancestor-identification system 102 can determine that a face (such as the identified target face 209 and/or an additional face) depicted in the source digital image 206 contains differences in physical appearance compared to a face contained or otherwise represented in the face-image index 212. The ancestor-identification system 102 can determine that the face depicted in the source digital image 206 corresponds to a same individual as a face depicted or otherwise represented in the face-image index 212 by determining that the differences in physical appearance of the face in the source digital image 206 and the face depicted or otherwise represented in the face-image index are within a facial similarity threshold.

As shown, responsive to identifying the matching digital image, the ancestor-identification system 102 can access an ancestor-recognition cluster database 214 to identify a matching cluster 215 corresponding to an individual depicted in the matching digital image (e.g., a potential match for the identified target face 209). The matching cluster 215 can contain genealogical content items (e.g., data records) for the individual depicted in the matching digital image (e.g., the source digital image 206) and can represent the individual with a cluster label of the representative member/individual of the matching cluster 215. For example, the matching cluster 215 can include a base node corresponding to the individual. Additionally, the matching cluster 215 can include one or more secondary nodes corresponding to genealogical content items (e.g., data records) for the individual depicted in the matching digital image. The secondary nodes can be connected to the base node by edges. While in embodiments secondary nodes are described as corresponding to genealogical content items, in embodiments the secondary nodes may refer to secondary or non-representative person nodes that share a cluster with the base node. In embodiments, the base node is selected automatedly based on a score based on, e.g., completeness of the node, historical-record corroboration of biographical details of the node, connectedness of the node with other nodes, concordance of biographical details of the node with other details, etc. In embodiments, the identified target face 209 may be matched against an image or other record associated variously with one, a plurality, or all of the nodes of a particular cluster.

As shown in FIG. 2, the ancestor-identification system 102 can output a face-match notification 218 responsive to identifying the matching cluster 215. In some embodiments, the ancestor-identification system 102 can utilize the face-match notification 218 to indicate a discovery of a matching digital image 220 (e.g., that the ancestor-identification system 102 discovered utilizing the face-image index 212) depicting a face within a threshold similarity of the identified target face 209. Further, in some embodiments, the ancestor-identification system 102 can request a confirmation and/or selection of the matching digital image 220 (e.g., an indication that an individual depicted in the matching digital image is a same individual depicted in the identified target face 209). Further, responsive to identifying the individual depicted by the identified target face 209, the ancestor-identification system 102 can update the matching cluster 215 in the ancestor-recognition cluster database 214 to include one or more additional secondary nodes associated with the individual. Further, the ancestor-identification system 102 can provide additional information about the individual depicted in the matching digital image 220, such as a name, birth date, a death date, an age, a confidence score that the information provided corresponds to the individual depicted in the matching digital image 220.

As illustrated in FIG. 2, as part of the face-match notification 218, the ancestor-identification system 102 can indicate a discovery of an additional matching digital image 222. Further, the ancestor-identification system 102 can provide additional information about the individual depicted in the additional matching digital image 222, such as a name, birth date, death date, age, and confidence score, among others. Indeed, the ancestor-identification system 102 can determine to indicate one or more additional matching digital images to the user account based on determining a plurality of potential matches from the face-image index 212.

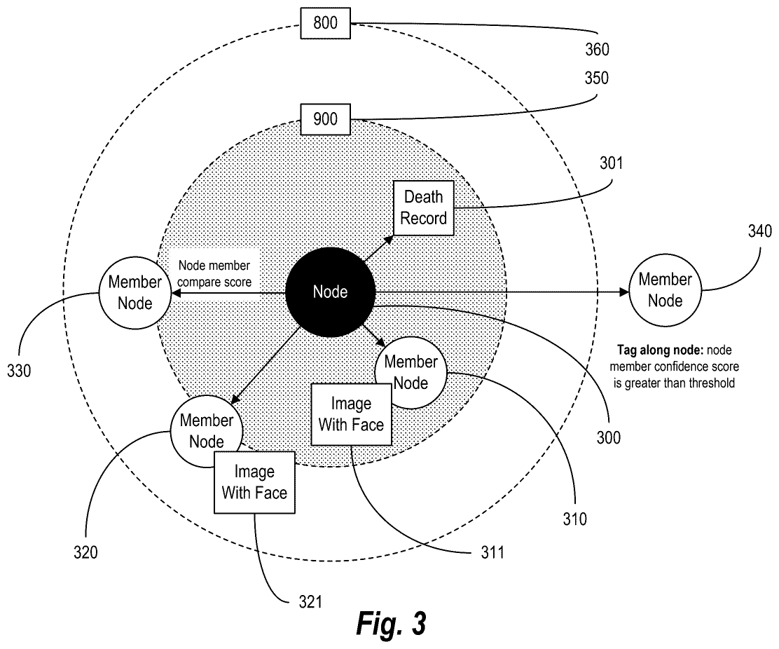

Moreover, in some embodiments, the ancestor-identification system 102 can use the face-image index 212 and/or the ancestor-recognition cluster database 214 to determine that the identified target face 209 corresponds to a deceased individual. For example, the ancestor-identification system 102 can access a plurality of records from tree nodes associated with the matching cluster 215 within the ancestor-recognition cluster database 214. The ancestor-identification system 102 can further determine a nonliving score from a death record, metadata from a birth event, or metadata from a marriage event more than 100 years prior to a current date. Indeed, the ancestor-identification system 102 can generate the nonliving score by combining data from various records. Upon determining that the nonliving score satisfies a threshold, the ancestor-identification system 102 determines that the target face 209 depicts a deceased individual. For instance, the ancestor-identification system 102 can extract data from the death record, the metadata from the birth event, and/or the metadata from the marriage event greater than 100 years prior to the present date to determine that the target face 209 corresponds to a deceased individual. More information regarding determining the nonliving score will be provided below with respect to the discussion of FIG. 3.

Further, the ancestor-identification system 102 can modify the face-match notification 218, the face-image index 212, and/or the ancestor-recognition cluster database 214 responsive to determining that the identified target face 209 corresponds to the deceased individual. Alternatively, in some embodiments, the ancestor-identification system 102 can determine that the identified target face 209 corresponds to a living individual. The ancestor-identification system 102 can modify the face-match notification 218, the face-image index 212, and/or the ancestor-recognition cluster database 214 responsive to determining that the identified target face 209 corresponds to a living individual. For example, the ancestor-identification system 102 can modify the face-match notification 218 by redacting information about the living individual according to one or more privacy directives. Moreover, in some embodiments, responsive to identifying the living individual, the ancestor-identification system 102 can determine not to provide the face-match notification 218. Further, the ancestor-identification system 102 can modify the ancestor-recognition cluster database 214 by updating edges within the matching cluster 215 to reflect relationships impacted by the source digital image 206 of the deceased individual.

Additionally, in some embodiments, the ancestor-identification system 102 can utilize the face-image index 212 to determine a matching digital image as a digital image depicting a face that corresponds to the face set 210 of the source digital image 206 (e.g., one or individuals whose face matches faces depicted in the source digital image 206 other than the identified target face 209). Further, the ancestor-identification system 102 can utilize the ancestor-recognition cluster database 214 to determine one or more additional matching clusters for faces of the face set 210.

Further, in some embodiments, the ancestor-identification system 102 can label or otherwise identify an additional individual from the face set 210 (e.g., within the source digital image 206) to render the source digital image 206 searchable by user accounts linked to the additional individual.

FIG. 3 illustrates the operation of a cluster of nodes, including a base node, other member nodes, and associated records or genealogical content items (e.g., digital images, newspaper articles, birth, marriage, death records, military records, and other data records/genealogical content items containing genealogical information as described below). As seen, the base node 300 may be associated within the ancestor-recognition cluster database 214 with a plurality of additional member nodes 310, 320, 330, 340 at varying degrees of confidence score thresholds 350, 360, confidence scores representing in embodiments a node member compare score, with each of the confidence scores being relative to the individual node and the base node. For instance, the member node 310 exceeds a confidence-score threshold 350 of 900, while member nodes 320, 330 fall within the confidence-score threshold 360 of 800, and member node 340 falls outside the confidence-score threshold 360.

The base node 300 may be associated with certain records, such as a death record 301. Depending on the threshold confidence scores for inclusion in the deceased-person index and/or in the ancestor-recognition cluster database 214, the base node 300 further may be associated with additional records, such as records 311, 321, which are associated with other nodes, and which may advantageously comprise images with faces, allowing for comparison against an uploaded image with an unidentified person. This advantageously collates records from throughout the ancestor-recognition cluster database 214 and tree database such that a user may upload an image with the face of an unknown person, and the image may be compared against all reliably related tree nodes and associated records in order to maximize the likelihood that the person will be able to identify the unknown person and unblock their further family history research thereby.

As previously mentioned, the ancestor-identification system 102 can determine a non-living score according to various criteria. Further, when determining the non-living score, the ancestor-identification system 102 can weigh the different criteria differently. For example, where the ancestor-identification system 102 determines that a node has a death event, the ancestor-identification system 102 can assign extra weight to: the death event criteria for each year deceased in the past; a count of tree nodes (e.g. of a cluster) that have the death event; a count of records attached to the event by users (e.g., through tree nodes); and/or a count of records attached to the death event by automatic stitching, e.g. via entity resolution performed within the ancestor-recognition cluster database 214 and/or the tree database. In embodiments, where a node has a birth date greater than 100 years before a present date, the ancestor-identification system 102 can assign extra weight to criteria of the non-living score for: each year above 100 years from the birth date to a present date; a count of tree nodes (e.g. of a cluster) that have a birth event; a count of records attached to the birth event by users; and/or a count of records attached to the birth event by automatic stitching. Additionally, in some embodiments, the ancestor-identification system 102 can determine a node has marriage or residence events greater than 100 years before a present date, the ancestor-identification system 102 can assign extra weight to the non-living score for: each year above 100 years from the marriage or residence event to a present date; a count of tree nodes (e.g. of a cluster) that include the marriage or residence event; a count of records attached to the marriage or residence event by users; and/or a count of records attached to the marriage or residence event by automatic stitching. Further, when determining non-living scores for individuals, responsive to determining two different non-living scores (e.g., from different tree nodes) corresponding to a same individual, the ancestor-identification system 102 compares the two non-living scores and chooses a first score of the two scores that is lower than a second score of the two scores. While selection of a lower score has been described, it will nonetheless be appreciated that the disclosure is not limited thereto, but rather the disclosure includes any suitable treatment of different scores, including determining and relying upon an average or median of a plurality of scores, relying upon one score rather than the other based on a determined reliability or completeness of an associated node, etc.

Further, in some embodiments, the ancestor-identification system 102 determines the non-living score by searching for and/or identifying a plurality of nodes (e.g., in a cluster database and/or in a tree database) that indicate an individual is deceased. For instance, the ancestor-identification system 102 determines nonliving scores for various nodes and compares the nonliving scores with a nonliving score threshold. Upon determining that a nonliving score for a node satisfies the threshold, the ancestor-identification system 102 selects the node as representing the deceased individual depicted in the face image. In some cases, the ancestor-identification system 102 identifies at least a threshold number of nodes (e.g., three nodes) from the matching cluster indicating (with at least a threshold nonliving score) that an individual is deceased to determine that the depicted individual is deceased.

Further, the ancestor-identification system 102 can determine different a number of types of evidences associated with a node that correspond to a non-living person. For example, the ancestor-identification system 102 can determine a first type of evidence of a number of tree nodes that indicate a person is deceased. Further, the ancestor-identification system 102 can determine a second type of evidence of a record source for a death event. Moreover, the ancestor-identification system 102 can determine a third type of evidence of a record source for a birth event greater than 100 years prior to a current date. Additionally, the ancestor-identification system 102 can determine a fourth type of evidence of a record source for a marriage or residence event greater than 100 years prior to a current date.

Table 1 below illustrates the effects of experimenting with different confidence scores on the number of clusters and media available (e.g., the ancestor-identification system 102 determining confidence scores for clusters according to one or more evidence types).

TABLE 1

| Confidence Score | Clusters (millions) | Media (millions) |
|---|---|---|
| High (900 & 3 + evidences) | 98 | 296 |
| Medium (600 & 2 + evidences) | 116 | 330 |
| Low (>400 & 1 + evidences) | 122 | 346 |
| Total | 133 | 376 |

As seen from Table 1, while a grand total of 133 million clusters with 376 million media (e.g. images and records) may be available in a deceased-person index, by limiting the records to those with “high” confidence scores (e.g. 900+ and 3 or more evidences, such as supporting records), the risk of providing information of living persons (as opposed to non-living persons) is correspondingly reduced, with only 98 million clusters and 296 million media available. The user, therefore, has access to a large number of clusters and media while protecting the privacy of living persons. Further, the 98 million clusters and associated media advantageously facilitate additional research by downstream users, such that the user's contributions—such as by saving a node belonging to a particular cluster to a pedigree—can benefit other users who then gain access to the nodes, data, and media in the pedigree, and vice versa.

While the confidence score thresholds of “high,” “medium,” and “low” (corresponding to 900, 800, and values less than 800, respectively, with the above-described numbers of associated evidences) have been described, it will be appreciated that these are merely exemplary and the disclosure is not limited thereto. Rather, in some embodiments, confidence scoring (e.g., on an arbitrary scale of 0-1000), may include any suitable number of thresholds or a range of values bounded by any two confidence score values within the scale. For example, a confidence threshold may be any of the numbers 50, 100, 200, 300, 400, 500, 600, 700, 800, 900, 950, 990, or any number therebetween and may comprise a range of values bounded by any two of the aforementioned values. On other scales, other thresholds and numbers thereof may be utilized as suitable. The confidence scores or thresholds may additionally, or alternatively, correspond to a number of records, as exemplified in Table 1 where 3+ evidences (or number of records or other metadata) corresponds to high confidence, 2+ evidences corresponds to medium confidence, and 1+ evidence corresponds to low confidence. It should be appreciated, however, that any combination of confidence score and suitable number of evidences may be utilized.

After identifying the unknown person via the ancestor-recognition cluster database, the user may be provided, at the user interface, one or more suggestions of who the unfamiliar person is. In embodiments, this may include providing one or more links to person profiles in a genealogical research system database, e.g. as represented by the representative member or base node of the matching cluster. The suggestions may be provided with informative metadata, such as name data, closest relatives' names, birth, marriage, and/or death dates and/or locations, associated public pedigrees, additional images, including a matching image, or any other suitable information. In embodiments, a user may select one or more of the suggestions, with a genealogical research service database being modified accordingly. In embodiments, the genealogical database, such as an ancestor-recognition cluster database, is modified by creating an edge between a node corresponding to the suggested/selected person and a node corresponding to the image from which the person was identified (e.g. the source digital image 206 of FIG. 2). This advantageously facilitates downstream benefits in and using the genealogical research service database as other users are enabled by the newly created edge to be linked to the source digital image 206 through the corresponding node which may be an existing node in a pertinent pedigree or may be added to a pertinent pedigree in later research. Accordingly the genealogical research service database becomes better able to facilitate successful, efficient, and emotionally engaging family history research by a plurality of users.

Additionally, when the ancestor-identification system 102 updates or otherwise modifies a node in an ancestor-recognition cluster database (e.g., the ancestor-recognition cluster database 214 of FIG. 2), the ancestor-identification system 102 can similarly modify (or instruct the genealogical entity-resolution system 700) a corresponding node in the cluster database 714. For example, ancestor-identification system 102 can generate the ancestor-recognition cluster database can contain a subset of nodes and/or clusters of the cluster database 714. Responsive to modifying a node/cluster in the ancestor-recognition cluster database, the ancestor-identification system 102 can modify/update a corresponding node/cluster in the cluster database 714, thus continually updating the cluster database 714.

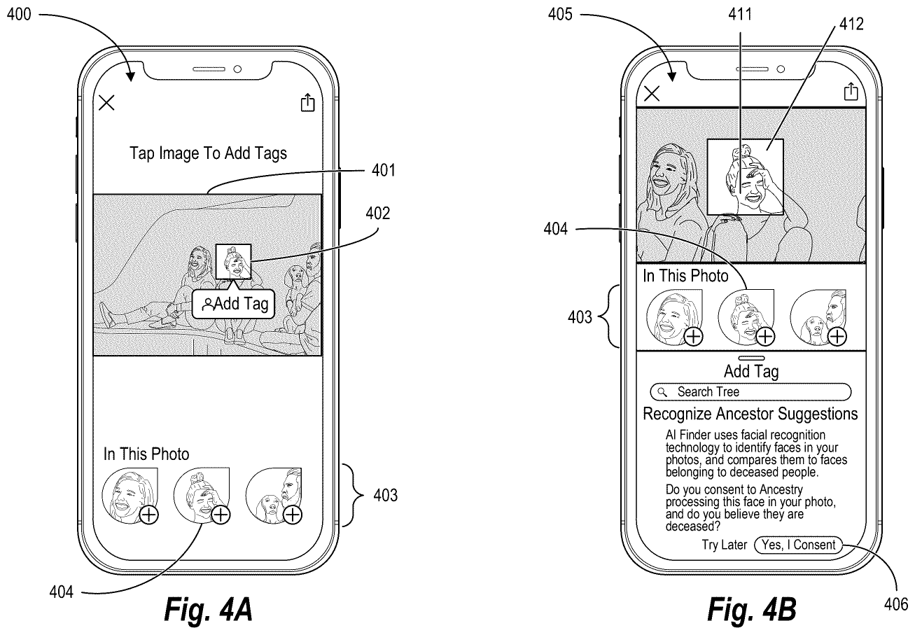

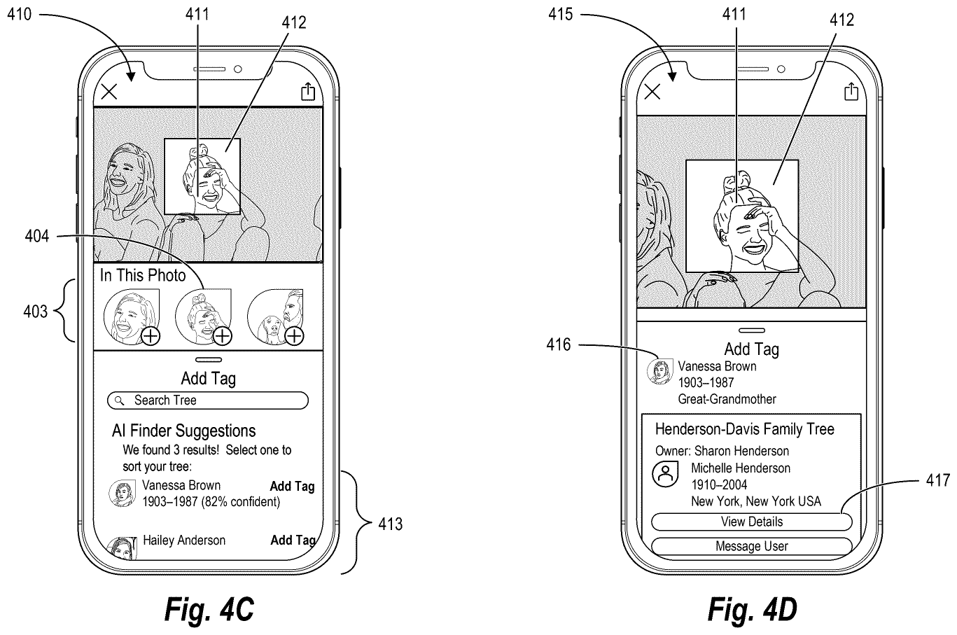

FIGS. 4A-4D illustrate an exemplary user experience with the ancestor-identification embodiments of the disclosure. In FIG. 4A, a user interface 400 is presented to a user, where the user may view an image 401 and apply tags 402 to individuals therein. A plurality of tagged individuals may be shown in a ribbon, carousel, or other modality 403, with a particular individual 404 being unknown to the user and/or not present in the user's family tree. Faces within the image may be automatedly identified by a suitable face-detection modality, such as a native face-detection tool available from Apple Inc. of Cupertino, CA or Google LLC of Menlo Park, CA, or Amazon Rekognition, available from Amazon.com, Inc., of Bellevue, WA, and automatedly segmented thereby for user selection. While the native face-detection tools of Apple, or Google, or Amazon Rekognition are described, it will be appreciated that the disclosure is not limited thereto, but rather may extend to any suitable face-detection modality. In other embodiments, face detection may be performed by the same modality as used for facial recognition. In embodiments, a user may opt-in to the use of an artificial-intelligence facial recognition modality by selecting a consent option via a user interface 405, as seen in FIG. 4B. The user interface 405 may be prompted when the individual is not identifiable by the ancestor-identification system and methods of embodiments, e.g. the facial-recognition modality is unable to locate the tagged individual in the media associated with the user's family tree. In embodiments, the user interface 405 may be prompted by a user selection or action, automatedly, or otherwise.

Additionally, or alternatively, as seen in FIG. 4B, the image 401 may be segmented or otherwise modified to image 411, where the selected individual 412 for tagging is the focus of the image 411. This may entail any suitable modality for adjusting an image by identifying the detected and selected face from the image 401, adjusting a zoom of the image, cropping portions of the image, or otherwise, such that the selected individual becomes the focus of the image 411. Additionally, the ancestor-identification system 102 can request permission from a user (e.g., a user account) to analyze images to identify people depicted in the images. The ancestor-identification system 102 can generate a consent option 406 to receive consent from the user.

As seen in FIG. 4C, a user interface 410 may be presented to the user, where the image 411 is shown and the selected individual 412 continues to be shown. A portion 413 of the user interface 410 may show one or more possible tree nodes for the selected individual 412. In embodiments, the possible tree nodes are identified as discussed above using an ancestor-recognition cluster database and/or a tree database of a genealogical research service. In embodiments, the possible tree nodes are identified by indexing the image 411 and/or the selected individual 412 against a specialized index of deceased individuals, the specialized index being, in embodiments, a subset of the ancestor-recognition cluster database comprising only clusters that have been determined to represent or correspond to deceased individuals using, in embodiments, the heuristics described herein.

As seen in FIG. 4C, a user may select one of the suggested nodes, e.g. a “Vanessa Brown,” to assign the same as a tag to the unknown individual. Thus an individual can add the node corresponding to Vanessa Brown to their tree and receive media, records, and relationships associated therewith. This advantageously allows a user, on the basis of an image alone, to discover a relationship with a previously unknown and possibly long-lost ancestor and unblock their further family history research thereabout, enabling greater emotional engagement by and with the user.

Further, as seen in FIG. 4D, in some embodiments, a user may be presented with a user interface 415 where a selected, suggested node 416 is shown. In embodiments, metadata pertaining to a relationship between the user and the person corresponding to the selected, suggested node 416, e.g. “Great-Grandmother,” is presented, along with profile image(s), data such as lifespan data, or other information as suitable. In embodiments, the ancestor-identification system 102 can provide the user an option 417 (e.g., a selectable option within a user interface) to view an account of a user from whose family tree the suggested node 416 was retrieved, suggesting a living person who is related to the user through the previously unknown person, along with certain details such as additional relatives, most-recent common ancestor, location and lifespan data, or otherwise as suitable. The living person to whom the user is shown to be related in the user interface 415 may be a user who has previously consented or opted in to having information about themselves, their profile, and/or their family tree shown in results generated by the embodiments.

Options selectable by the user may include a messaging modality and/or a view modality. In any of the described embodiments, it will be appreciated that a focus, zoom, or other attribute of the image 411 may be adjusted as suitable based on the current user interface. For example, as seen in the user interface 415 of FIG. 4D, when a user has selected a suggested tree node and “found out” who their previously unknown ancestor is, the image 411 may zoom in further than the foregoing user interface examples to allow the user to become better acquainted with their now-found ancestor.

In embodiments, when a user selects a suggested node 416 to tag the previously unknown individual, the genealogical research service database(s) may be modified accordingly. For example, an edge may be generated between nodes thereof, allowing a user's family tree to connect to other family trees via the selected node; cluster(s) associated with the selected node may likewise be correspondingly modified, facilitating connections between the discrete trees generated by different users, and thereby allowing disparate users to discover each other, access long-lost records, and facilitating more-fruitful genealogical research. This yields, accordingly, a transformed, specialized database configured to effectively, efficiently, and compliantly facilitate genealogical research regarding photographed but unidentified ancestors or other persons of interest to a user.

It will be appreciated that while heuristics for determining whether a cluster represents a deceased person have been described, the disclosure is not limited thereto, but rather may extend to other suitable modalities for determining whether the person is deceased. For example, machine-learned modalities for classifying clusters as corresponding to deceased persons or living persons may be utilized as suitable. Additionally, while a specialized index has been described, it will be appreciated that the disclosure is not limited thereto, but rather an image corresponding to an individual unknown to a user may be matched against a standard cluster, tree, or other database as suitable for identifying a match on the basis of facial similarities. Additionally, while an index specific to deceased persons has been described, it will be appreciated that in other embodiments, an image corresponding to an individual unknown to a user may be matched against a standard cluster, tree, or other database as suitable for identifying a match on the basis of facial similarities without being limited to deceased persons.

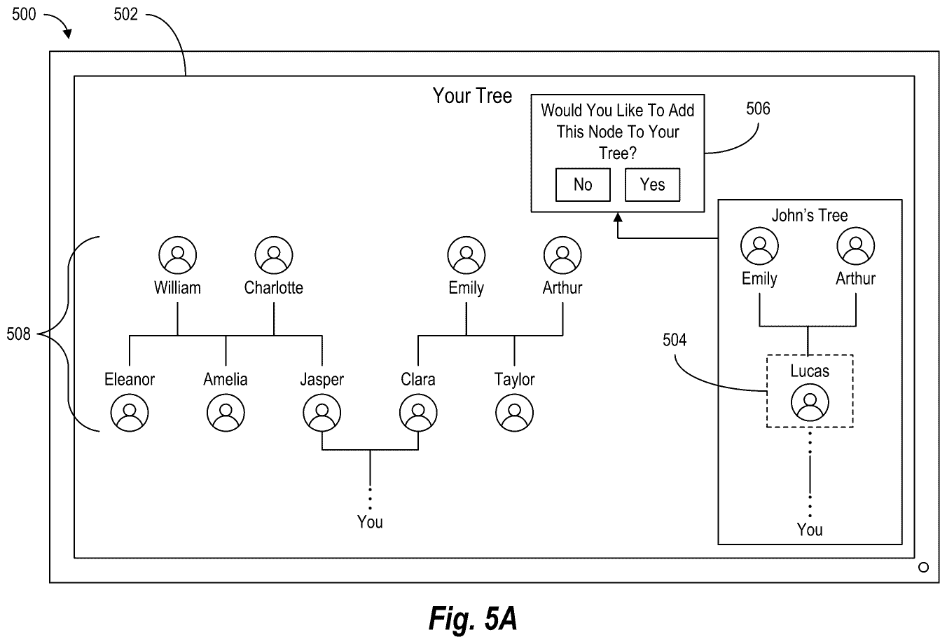

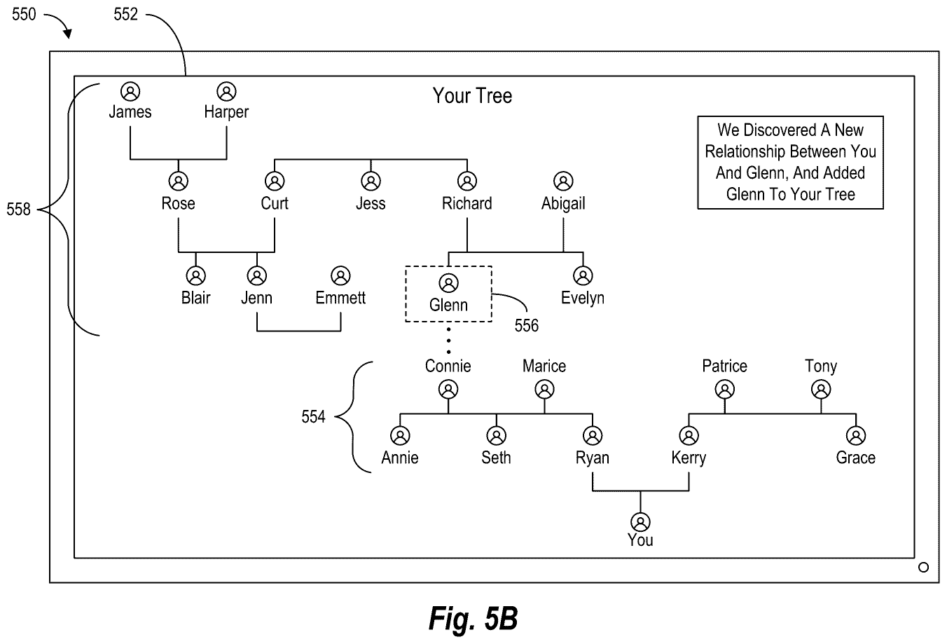

As previously mentioned, the ancestor-identification system 102 can generate a genealogy tree. FIGS. 5A-5B illustrate the ancestor-identification system 102 generating face-match notifications by generating or otherwise updating genealogy trees in accordance with one or more embodiments.

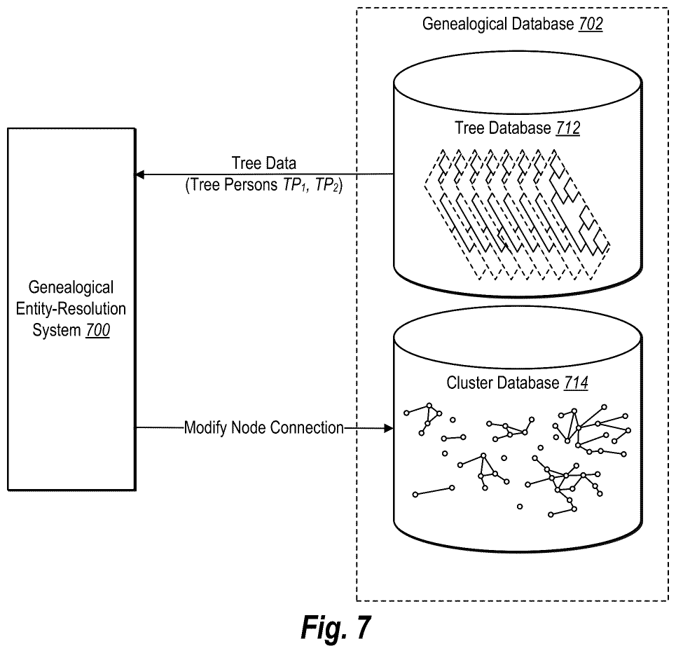

For example, the ancestor-identification system 102 can determine a matching cluster (e.g., by determining a confidence score such as a non-living score) for an as-yet unidentified, deceased individual depicted in a source digital image. Responsive to determining the matching cluster, the ancestor-identification system 102 can analyze the matching cluster, an ancestor-recognition cluster database, and/or a tree database to determine one or more genealogical relationships between the individual and other individuals in the ancestor-recognition cluster database/tree database, such as an individual corresponding to a user account. More information regarding determining relationships between clusters in an ancestor-recognition cluster database and tree nodes in a tree database is provided below with regards to FIG. 7. Responsive to determining the one or more genealogical relationships, the ancestor-identification system 102 can update and/or otherwise provide an indication of an update to a genealogy tree corresponding to a user account.

As illustrated in FIG. 5A, in some embodiments, the ancestor-identification system 102 can generate an indication of a genealogy tree (e.g., as part of a face-match notification) by generating a preview of a genealogical tree of a third party (e.g., “John's Tree”) in a user interface 502 of a client device 500. For example, the ancestor-identification system 102 can determine a genealogical tree corresponding to an individual from a matching cluster (e.g., a genealogical tree that includes one or more relationships with the individual). The ancestor-identification system 102 can determine, according to one or more privacy directives, to generate the preview of the genealogical tree of a third party user account (e.g., “John's Tree). The preview of the genealogical tree can include one or more relationships associated with the user's genealogical tree that were previously not associated or otherwise displayed with on the genealogical tree associated with the user account.

To illustrate, the ancestor-identification system 102 can determine, responsive to receiving a source digital image and identifying a target face, a matching cluster associated with “Lucas” (e.g., an individual corresponding to a target face in a source digital image). Based on identifying the matching cluster associated with Lucas, the ancestor-identification system 102 can analyze an ancestor-recognition cluster database and a tree database to determine genealogical relationships between a user corresponding to a user account and the individual corresponding to the target face (e.g., “Lucas”). For example, the ancestor-identification system 102 can identify one or more common tree nodes (e.g., corresponding to people) between a first genealogical tree corresponding to the user account and a second genealogical tree corresponding to a third-party user account (e.g., John).

Indeed, as illustrated in FIG. 5A, the ancestor-identification system 102 can determine that a genealogical tree 508 corresponding to the user account (e.g., the first genealogical tree) and genealogical tree corresponding to the third-party user account (e.g., “John's Tree,” the second genealogical tree) have one or more common tree nodes (e.g., Emily and Arthur). Based on this determination, the ancestor-identification system 102 can identify an additional tree node 504 corresponding to the one or more common tree nodes that are present in the second genealogical tree, but that are not present in the first genealogical tree. For example, “John's Tree” and “Your Tree” both contain nodes corresponding to Emily and Arthur. However, “John's Tree” has the additional tree node 504, “Lucas,” that is connected to Emily and Arthur, whereas the genealogical tree 508 is missing the additional tree node 504 corresponding to “Lucas.” Responsive to this determination, the ancestor-identification system 102 can generate a face-match notification 506 (e.g., “Would You Like To Add This Node To Your Tree”) to indicate a discovery of a relationship between a user corresponding to the user account and a second individual corresponding to a target face depicted in a source digital image. In embodiments, the face-match notification 506 may include an indicium regarding a potential placement of the additional tree node 504 (in the example of FIG. 5A, with the additional tree node 504 corresponding to Lucas inserted adjacent to Clara and/or Taylor and subjacent to Emily and Arthur), such that the additional tree node 504 node for Lucas is shown in an appropriate position in the genealogical tree 508 such that the user can review the placement and confirm accuracy by selecting “Yes” in the face-match notification.

Additionally, as shown in FIG. 5B, in some embodiments, the ancestor-identification system 102 can directly modify a genealogical tree 554 of a user account in a user interface 552 of a client device 550 (e.g., as opposed to displaying a preview of a genealogical tree of a third-party). Responsive to determining a matching cluster corresponding to an individual depicted in a source digital image, the ancestor-identification system 102 can analyze an ancestor-recognition cluster database to determine a non-living score for the individual that indicates the individual is deceased.

Responsive to determining the non-living score that indicates the individual is deceased, the ancestor-identification system 102 can analyze a tree database to determine a genealogical relationship between the individual and a user of the user account. Based on determining the genealogical relationship, the ancestor-identification system 102 can generate a face-match notification by updating the genealogical tree 554 of the user account to indicate the genealogical relationship between the user and the individual. In some embodiments, the ancestor-identification system 102 can update the genealogical tree of the user account by adding a new node 556 corresponding to the individual and one or more nodes connecting the new node to one or more existing nodes in the genealogical tree 554. Further, the new node 556 can correspond to a base node of the matching cluster of the ancestor-recognition cluster database.

As illustrated in FIG. 5B, based on adding the new node 556, the ancestor-identification system 102 can update the genealogy tree of a user account by adding a new section 558 including one or more new nodes to the genealogical tree 554 of the user account (e.g., “We Discovered A New Relationship Between You and Glenn, And Added Glenn To Your Tree”). The ancestor-identification system 102 can generate a path of the genealogy tree 554 of the user account linking a first node corresponding to the user account (e.g., “You”) associated with the client device 550 and the new node 556 (e.g., “Glenn”). The path can include one or more additional nodes and one or more edges connecting the first node to the new node 556. Further, the new node 556 can correspond to the individual identified in the matching cluster. As illustrated by FIG. 5B, based on identifying the ancestor-identification system 102 can modify the genealogical tree 554 by adding the new section 558 (or a new branch) that comprises a plurality of nodes and edges extending or originating from the new node 556.

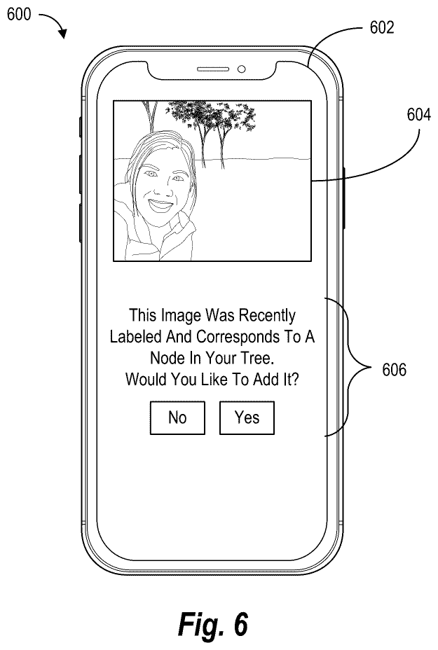

As previously mentioned, the ancestor-identification system 102 can generate a face-match notification. FIG. 6 illustrates the ancestor-identification system 102 generating a face-match notification in accordance with one or more embodiments.

In some embodiments, the ancestor-identification system 102 can generate a face-match notification 606 in a user interface 602 of a client device 600. Specifically, the ancestor-identification system 102 can generate the face-match notification 606 indicating an update to a node of a genealogical tree of a user account. For example, the ancestor-identification system 102 can update the node of the genealogical tree to include an image depicting an individual corresponding to the node.

For example, the ancestor-identification system 102 can receive a source digital image from a third-party user account (e.g., a user account that does not have any association with the user account. The ancestor-identification system 102 can determine that the source digital image depicts a target face and one or more additional faces. In addition to identifying an individual corresponding to the target face, the ancestor-identification system 102 can utilize a face-image index (e.g., the face-image index 212 of FIG. 2) and an ancestor-recognition cluster database (e.g., the ancestor-recognition cluster database 214 of FIG. 2) to identify one or more individuals that correspond to the one or more additional faces. The ancestor-identification system 102 can determine one or more genealogical trees (e.g., genealogical trees for additional third-party user accounts) that include nodes corresponding to at least one of the one or more individuals and update the one or more genealogical trees to include at least a segment 604 of the one or more source digital images that depict the one or more individuals.

FIG. 7 illustrates a genealogical entity-resolution system 700. Entity resolution is a long-studied problem that still poses some interesting challenges. The problem is defined as identifying and linking different manifestations of the same real-world object. Many organizations collect data on entities with potential duplicate data. For certain genealogical databases, each group of user nodes or records may be considered in the format of a genealogical tree or records connected by biological and other family relationships which will be designated herein by the general term “tree data.” Tree data nodes often have overlap with other tree data nodes which creates duplicate entities in a genealogical database. One way to track known duplicates is to resolve multiple entities into one cluster. This provides immense value to users by allowing them to receive more targeted hints, understand how they are related to people in records outside their personal tree, and have a more precise searching capabilities.

Genealogical data (e.g., data records and/or genealogical data objects) may be received from a source selected from the group consisting of the Ancestry World Tree system, a Social Security Death Index database, the World Family Tree system, a birth certificate database, a death certificate database, a marriage certificate database, an adoption database, a draft registration database, a veterans database, a military database, a property records database, a census database, a voter registration database, a phone database, an address database, a newspaper database, an immigration database, a family history records database, a local history records database, a business registration database, and a motor vehicle database. Additionally, genealogical data can be user-generated. Genealogical data may also include data from a clustered database derived from records and user data.

Some embodiments of the present disclosure relate to modifying an ancestor-recognition cluster database when it is determined that two persons in different trees data collections correspond to the same individual. In some instances, a node connection may be generated between two nodes corresponding to the two persons in different trees. This technique may be used incrementally during the generation of the ancestor-recognition cluster database. Thus, as a user creates a new node or edits an existing node, the disclosed technique may be used to check whether that node resolves to a current entity cluster or whether it should generate its own cluster. Additionally, this technique may be used as users utilize the ancestor-identification embodiments to generate new nodes in their own tree based on an identification of a previously unknown person from an image based on a match identified in an existing node of an existing tree and/or cluster.

Another advantage of identifying these duplicate persons is that one user or record collection may have information for their ancestor that another user does not. As more duplicate persons are identified, rather than list every duplicate person for the user to browse, it may be more helpful to show a user an aggregation of all the duplicates merged together in a single, concise view of the cluster (i.e., a grouping of duplicate persons). Another advantage of identifying duplicate persons is that if users A and B have a duplicate person in their family trees, then it can be determined that users A and B are related to each other at least via the duplicate person. Furthermore, once the duplicate person is identified, user A may supplement his/her family tree with information from user B's family tree, and vice-versa.

As seen in FIG. 7, the genealogical entity-resolution system 700 includes a genealogical database 702, which may include a tree database 712 and a cluster database 714. The tree database 712 may be configured to facilitate the generation, storage, and collation of family trees for a plurality of users, with trees comprising nodes and edges therebetween. Data and records, such as images, may be associated with individual nodes of the trees in the tree database 712. Tree person data, including data such as names, relationships, dates, events, and other metadata may be provided by the tree database 712 to the genealogical entity-resolution system 700. The cluster database 714 may include one or more clusters comprising resolved entities, where tree persons (nodes) in different trees in the tree database 712 are associated together in a cluster after determination that the tree persons correspond to a same person. Further, the cluster database 714 can include the ancestor-recognition cluster database 214 of FIG. 2.

As a user expands their family tree, e.g. by tagging a previously unknown person in an image using the suggestions provided by the ancestor-identification system and adding the now-identified person to their tree as a new node, the tree database 712 may be modified as the user's family tree is expanded, and the cluster database 714 may be modified to include the new node in the pertinent cluster.

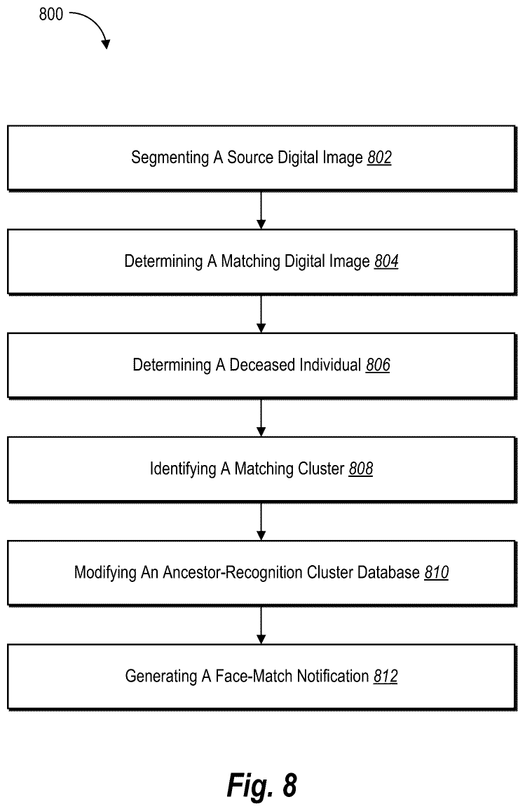

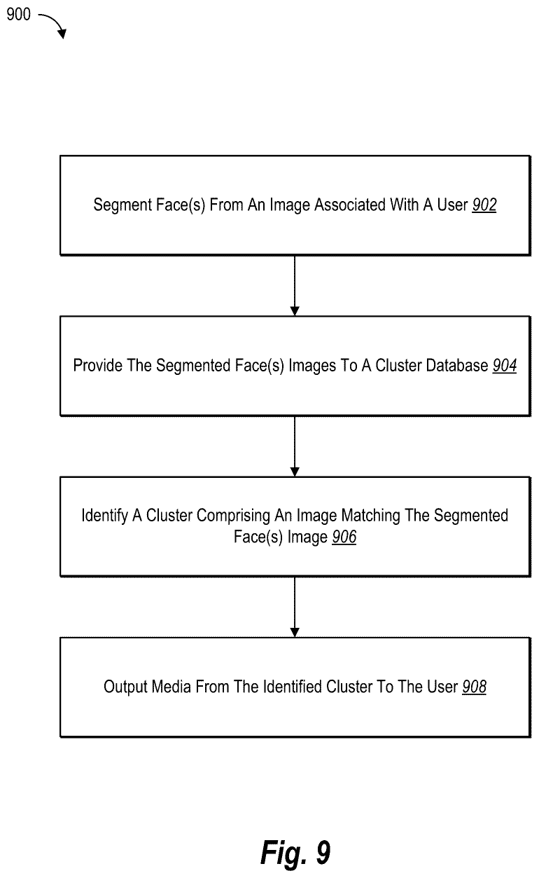

FIGS. 1-7, the corresponding text, and the examples provide a number of different systems and methods for segmenting images to detect a target face, identifying a matching digital image, and generating a face-match notification. In addition to the foregoing, implementations can also be described in terms of flowcharts comprising acts or steps in a method for accomplishing a particular result. For example, FIGS. 8-9 represent series of acts (e.g., a computer-implemented method) for segmenting images and determining matches to the image.

While FIGS. 8-9 illustrate acts according to certain implementations, alternative implementations may omit, add to, reorder, and/or modify any of the acts shown in FIGS. 8-9, The acts of FIGS. 8-9 can be performed as part of a method. Alternatively, a non-transitory computer-readable medium can comprise instructions stored thereon that, when executed by at least one processor, cause a computing device to perform the acts of FIGS. 8-9. In still further implementations, a system can perform the acts of FIGS. 8-9.

As illustrated in FIG. 8, the ancestor-identification system 102 can perform a series of acts 800. The series of acts 800 can include an act 802 of segmenting a source digital image. In particular, the act 802 can include segmenting a source digital image to detect a target face depicted in the source digital image. Further, the series of acts 800 can include an act 804 of determining a matching digital image. In particular, the act 804 can include determining, based on segmenting the source digital image and by analyzing a face-image index comprising a plurality of digital images depicted faces of individuals, a matching digital image depicting a face within a threshold similarity of the target face depicted in the source digital image. Additionally, the series of acts 800 can include an act 806 of determining a deceased individual. Specifically, the act 806 can include determining, based on analyzing the face-image index, that the target face depicted in the source digital image corresponds to a deceased individual. Further, the series of acts 800 can include an act 808 of identifying a matching cluster. Specifically, the act 808 can include identifying, based on the matching digital image and from an ancestor-recognition cluster database comprising clusters of data records corresponding to respective individuals, a matching cluster corresponding to the deceased individual depicted in the matching digital image. Moreover, the series of acts 800 can include an act 810 of modifying an ancestor-recognition cluster database. Specifically, the act 810 can include modifying the ancestor-recognition cluster database by updating edges within the matching cluster to reflect relationships impacted by the source digital image of the deceased individual. In addition, the series of acts 800 can include an act 812 of generating a face-match notification. In particular, the act 812 can include generating, for display on a client device, a face-match notification indicating the deceased individual from the matching cluster.

Additionally, in one or more embodiments, the series of acts 800 can include determining that the target face depicted in the source digital image corresponds to the deceased individual by determining a nonliving score for the deceased individual from a plurality of nodes of a tree database.

Further, in one or more embodiments, the series of acts 800 can include generating the face-match notification by generating, for display on the client device, an indication of a genealogy tree including the individual from the matching cluster.

Moreover, in some embodiments, the series of acts 800 can include generating a path of the genealogy tree linking a first node corresponding to a user account associated with the client device and a second node corresponding to the individual of the matching cluster.

In addition, in one or more embodiments, the series of acts 800 can include identifying, from the face-image index, an additional digital image corresponding to the target face depicted in the source digital image. Further, the series of acts 800 can include providing, for display on the client device, a notification of the additional digital image. Additionally, the series of acts 800 can include receiving, from the client device, a confirmation verifying a match for the additional digital image.

Further, in one or more embodiments, the series of acts 800 can include modifying, based on identifying the matching cluster for the target face depicted in the source digital image, a genealogy tree of a user account associated with the client device to include the source digital image.

Additionally, in some embodiments, the series of acts 800 can include identifying an additional face depicted in the source digital image. Further, the series of acts 800 can include determining, by analyzing the face-image index, an additional matching digital image depicting a face of an additional individual that corresponds to the additional face. Moreover, the series of acts 800 can include identifying, by analyzing the ancestor-recognition cluster database using the additional matching digital image, an additional matching cluster corresponding to the additional individual depicted in the source digital image. Indeed, the series of acts 800 can include labeling the additional individual within the source digital image to render the source digital image searchable by user accounts linked to the additional individual.

Moreover, in one or more embodiments, the series of acts 800 can include receiving a source digital image from a client device associated with a user account. Further, the series of acts 800 can include segmenting the source digital image to detect a target face depicted in the source digital image. In addition, the series of acts 800 can include determining, based on segmenting the source digital image and by analyzing a face-image index comprising a plurality of digital images depicting faces of individuals, a matching digital image depicting a face within a threshold similarity of the target face depicted in the source digital image. Further, the series of acts 800 can include determining, based on analyzing the face-image index, that the target face depicted in the source digital image corresponds to a deceased individual. Indeed, the series of acts 800 can include identifying, based on the one or more matching digital images and from an ancestor-recognition cluster database comprising clusters of data records corresponding to respective individuals, a matching cluster corresponding to an individual depicted in the one or more matching digital images. Moreover, the series of acts 800 can include modifying the ancestor-recognition cluster database by updating edges within the matching cluster to reflect relationships impacted by the source digital image of the deceased individual. Additionally, the series of acts 800 can include generating, for display on the client device, a face-match notification indicating the individual from the matching cluster.

Further, in some embodiments, the series of acts 800 can include determining that the target face depicted in the source digital image corresponds to the deceased individual by determining a nonliving score for the deceased individual from a plurality of nodes of a tree database.

In addition, in one or more embodiments, the series of acts 800 can include generating the face-match notification by generating, for display on the client device, an indication of a genealogy tree including the individual from the matching cluster.

Moreover, in some embodiments, the series of acts 800 can include to generating a path of a genealogy tree linking a first node corresponding to a user account associated with the client device and a second node corresponding to the individual of the matching cluster.

Further, in one or more embodiments, the series of acts 800 can include identifying, from the face-image index, one or more additional digital images corresponding to the target face depicted in the source digital image. Additionally, the series of acts 800 can include providing, for display on the client device, a notification of the one or more additional digital images. Moreover, the series of acts 800 can include receiving, from, the client device, a confirmation verifying a match for at least one of the one or more additional digital images.

In addition, in one or more embodiments, the series of acts 800 can include modifying, based on identifying the matching cluster for the target face depicted in the source digital image, a genealogy tree of a user account associated with the client device to include the source digital image.

Moreover, in some embodiments, the series of acts 800 can include identifying an additional face depicted in the source digital image. Additionally, the series of acts 800 can include determining, by analyzing the face-image index, an additional matching digital image depicting a face of an additional individual that corresponds to the additional face. Further, the series of acts 800 can include identifying, by analyzing the ancestor-recognition cluster database using the additional matching digital image, an additional matching cluster corresponding to the additional individual depicted in the source digital image. Additionally, the series of acts 800 can include labeling the additional individual within the source digital image to render the source digital image searchable by user accounts linked to the additional individual.

In addition, in one or more embodiments, the series of acts 800 can include segmenting a source digital image to detect a target face depicted in the source digital image. Indeed, the series of acts 800 can include determining, based on segmenting the source digital image and by analyzing a face-image index comprising a plurality of digital images depicting faces of individuals, a matching digital image depicting a face within a threshold similarity of the target face depicted in the source digital image. Additionally, the series of acts 800 can include determining, based on analyzing the face-image index, that the target face depicted in the source digital image corresponds to a deceased individual. Further, the series of acts 800 can include identifying, based on the matching digital image and from an ancestor-recognition cluster database comprising clusters of data records corresponding to respective individuals, a matching cluster corresponding to an individual depicted in the matching digital image. Moreover, the series of acts 800 can include modifying the ancestor-recognition cluster database based on identifying the matching cluster by updating edges within the matching cluster to reflect relationships impacted by the source digital image of the deceased individual. Additionally, the series of acts 800 can include generating, for display on a client device, a face-match notification indicating the individual from the matching cluster.

Further, in some embodiments, the series of acts 800 can include determining that the target face depicted in the source digital image corresponds to the deceased individual by determining a nonliving score for the deceased individual from a plurality of nodes of a tree database.

Moreover, in one or more embodiments, the series of acts 800 can include generating the face-match notification by generating, for display on the client device, an indication of a genealogy tree including the individual from the matching cluster.

Moreover, in one or more embodiments, the series of acts 800 can include generating a path of a genealogy tree linking a first node corresponding to a user account associated with the client device and a second node corresponding to the individual of the matching cluster.

Additionally, in some embodiments, the series of acts 800 can include identifying, from the face-image index, an additional digital image corresponding to the target face depicted in the source digital image. Further, the series of acts 800 can include providing for display on the client device, a notification of the additional digital image. Indeed, the series of acts 800 can include receiving, from the client device, a confirmation verifying a match for the additional digital image.

Further, in one or more embodiments, the series of acts 800 can include modifying, based on identifying the matching cluster for the target face depicted in the source digital image, a genealogy tree of a user account associated with the client device to include the source digital image.

FIG. 9 represents a method 900 for identifying an ancestor. Method 900 may include one or more of the following steps; fewer steps; additional steps; different ordering of steps; or otherwise, and is not limited to the exemplary discussion herein. Method 900 may include a step 902 of segmenting a face image from an image associated with a user, such as a user-uploaded family photo, where the segmented face images facilitate tagging of the user-uploaded family photo. The segmentation may be performed using any suitable face-detection or facial-recognition modality. The step 902 may be performed only after a user has provided informed consent regarding the use of the embodiments described herein to identify individuals in the image.

The method 900 may further include a step 904 of providing the segmented face image to an ancestor-recognition cluster database for identification of the individual represented therein. The ancestor-recognition cluster database may compare the face image against face images from a plurality of clusters representing individuals in the ancestor-recognition cluster database to determine similarities therebetween, for which purpose the ancestor-recognition cluster database may cooperate with a suitable facial-recognition modality.

The method 900 may further include a step 906 of identifying a cluster in the ancestor-recognition cluster database comprising an image matching the segmented face images. That is, upon determining, using, in embodiments, the facial-recognition modality, the cluster corresponding to the image that matches the segmented face image may be identified as the individual represented in the face image. A step 908 may include outputting media, such as additional images, family trees, metadata, or otherwise to the user from the identified cluster. This advantageously allows the user to emotionally engage with the information and further their family-history research.

Embodiments of the present disclosure may comprise or utilize a special purpose or general-purpose computer including computer hardware, such as, for example, at least one processor and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates an example computer system 1000 comprising various hardware elements, in accordance with some embodiments of the present disclosure. The computer system 1000 may be incorporated into or integrated with devices described herein and/or may be configured to perform some or all of the steps of the methods provided by various embodiments. It should be noted that FIG. 10 is meant only to provide a generalized illustration of various components, any or all of which may be utilized as appropriate. FIG. 10, therefore, broadly illustrates how individual system elements may be implemented in a relatively separated or relatively more integrated manner.

In the illustrated example, the computer system 1000 includes a communication module 1002, one or more processor(s) 1004, one or more AI module(s) 1005, one or more input and/or output device(s) 1030, and a storage 1001 comprising instructions 1003 for implementing an image enhancement system and/or method according to the disclosure. The computer system 1000 may be implemented using various hardware implementations and embedded system technologies. For example, one or more elements of the computer system 1000 may be implemented as a field-programmable gate array (FPGA), such as those commercially available by XILINX®, INTEL®, or LATTICE SEMICONDUCTOR®, a system-on-a-chip (SoC), an application-specific integrated circuit (ASIC), an application-specific standard product (ASSP), a microcontroller, and/or a hybrid device, such as an SoC FPGA, among other possibilities. In some embodiments, a device 1007 can host the communication module 1002, the one or more AI module(s) 1005, the one or more processor(s), a communications subsystem 1010, and the storage 1001 (including the instructions 1003).

The various hardware elements of the computer system 1000 may be communicatively coupled via the communication module 1002. While the communication module 1002 is illustrated as a single connection for purposes of clarity, it should be understood that the communication module 1002 may include various numbers and types of communication media for transferring data between pertinent components such as hardware elements. For example, the communication module 1002 may include one or more wires (e.g., conductive traces, paths, or leads on a printed circuit board (PCB) or integrated circuit (IC), microstrips, striplines, coaxial cables), one or more optical waveguides (e.g., optical fibers, strip waveguides), and/or one or more wireless connections or links (e.g., infrared wireless communication, radio communication, microwave wireless communication), among other possibilities.

In some embodiments, the communication module 1002 may include one or more buses connecting pins of the hardware elements of the computer system 1000. For example, the communication module 1002 may include a bus that connects the processor(s) 1004 with the storage 1001, referred to as a system bus, and a bus that connects the storage 1001 with the input device(s) and/or output device(s) 1030, referred to as an expansion bus. The system bus may itself consist of several buses, including an address bus, a data bus, and a control bus. The address bus may carry a memory address from the processor(s) 1004 to the address bus circuitry associated with the storage 1001 in order for the data bus to access and carry the data contained at the memory address back to the processor(s) 1004. The control bus may carry commands from the processor(s) 1004 and return status signals from the storage 1001. Each bus may include multiple wires for carrying multiple bits of information and each bus may support serial or parallel transmission of data.

The processor(s) 1004 may include one or more central processing units (CPUs), graphics processing units (GPUs), neural network processors or accelerators, digital signal processors (DSPs), and/or other general-purpose or special-purpose processors capable of executing instructions. A CPU may take the form of a microprocessor, which may be fabricated on a single IC chip of metal-oxide-semiconductor field-effect transistor (MOSFET) construction. The processor(s) 1004 may include one or more multi-core processors, in which each core may read and execute program instructions concurrently with the other cores, increasing speed for programs that support multithreading.

The input device(s) 1030 may include one or more of various user input devices such as a mouse, a keyboard, a microphone, as well as various sensor input devices, such as an image capture device, a pressure sensor (e.g., barometer, tactile sensor), a temperature sensor (e.g., thermometer, thermocouple, thermistor), a movement sensor (e.g., accelerometer, gyroscope, tilt sensor), a light sensor (e.g., photodiode, photodetector, charge-coupled device), and/or the like. The input device(s) 1030 may also include devices for reading and/or receiving removable storage devices or other removable media. Such removable media may include optical discs (e.g., Blu-ray discs, DVDs, CDs), memory cards (e.g., CompactFlash card, Secure Digital (SD) card, Memory Stick), floppy disks, Universal Serial Bus (USB) flash drives, external hard disk drives (HDDs) or solid-state drives (SSDs), and/or the like.

The output device(s) 1030 may include one or more of various devices that convert information into human-readable form, such as without limitation a display device, a speaker, a printer, a haptic or tactile device, and/or the like. The output device(s) 1030 may also include devices for writing to removable storage devices or other removable media, such as those described in reference to the input device(s). The output device(s) 1030 may also include various actuators for causing physical movement of one or more components. Such actuators may be hydraulic, pneumatic, electric, and may be controlled using control signals generated by the computer system 1000.

The communications subsystem 1010 may include hardware components for connecting the computer system 1000 to systems or devices that are located external to the computer system 1000, such as over a computer network. In various embodiments, the communications subsystem 1010 may include a wired communication device coupled to one or more input/output ports (e.g., a universal asynchronous receiver-transmitter (UART)), an optical communication device (e.g., an optical modem), an infrared communication device, a radio communication device (e.g., a wireless network interface controller, a BLUETOOTH® device, an IEEE 502.11 device, a Wi-Fi device, a Wi-Max device, a cellular device), combinations thereof, or other suitable possibilities.

The storage 1001 may include the various data storage devices of the computer system 1000. For example, the storage 1001 may include various types of computer memory with various response times and capacities, from faster response times and lower capacity memory, such as processor registers and caches (e.g., L0, L1, L2), to medium response time and medium capacity memory, such as random-access memory (RAM), to lower response times and lower capacity memory, such as solid-state drives and hard drive disks. While the processor(s) 1004 and the storage 1001 are illustrated as being separate elements, it should be understood that the processor(s) 1004 may include varying levels of on-processor memory, such as processor registers and caches that may be utilized by a single processor or shared between multiple processors.

The storage 1001 may include a main memory, which may be directly accessible by the processor(s) 1004 via the memory bus of the communication module 1002. For example, the processor(s) 1004 may continuously read and execute instructions stored in the main memory. As such, various software elements may be loaded into the main memory so as to be read and executed by the processor(s) 1004 as illustrated in FIG. 10. Typically, the main memory is volatile memory, which loses all data when power is turned off and accordingly needs power to preserve stored data.

The main memory may further include a small portion of non-volatile memory containing software (e.g., firmware, such as BIOS) that is used for reading other software stored in the storage 1001 into the main memory. In some embodiments, the volatile memory of the main memory is implemented as RAM, such as dynamic random-access memory (DRAM), and the non-volatile memory of the main memory is implemented as read-only memory (ROM), such as flash memory, erasable programmable read-only memory (EPROM), or electrically erasable programmable read-only memory (EEPROM).

The computer system 1000 may include software elements, shown as being currently located within the main memory, which may include an operating system, device driver(s), firmware, compilers, and/or other code, such as one or more application programs, which may include computer programs provided by various embodiments of the present disclosure. Merely by way of example, one or more steps described with respect to any methods discussed above, may be implemented as instructions 1003, which are executable by the computer system 1000. In one example, such instructions 1003 may be received by the computer system 1000 using the communications subsystem 1010 (e.g., via a wireless or wired signal that carries the instructions 1003), carried by the communication module 1002 to the storage 1001, stored within the storage 1001, read into the main memory, and executed by the processor(s) 1004 to perform one or more steps of the described methods.

In another example, the instructions 1003 may be received by the computer system 1000 using the input device(s) 1030 (e.g., via a reader for removable media), carried by the communication module 1002 to the storage 1001, stored within the storage 1001, read into the main memory, and executed by the processor(s) 1004 to perform one or more steps of the described methods.

In some embodiments of the present disclosure, the instructions 1003 are stored on a computer-readable storage medium (or simply computer-readable medium). Such a computer-readable medium may be a hardware storage device that, compared to transmission media or carrier waves, is “non-transitory” and may therefore be referred to as a non-transitory computer-readable medium. In some cases, the non-transitory computer-readable medium may be incorporated within the computer system 1000. For example, the non-transitory computer-readable medium may be the storage 1001 and/or the cloud storage 1050 (as shown in FIG. 10).

In some cases, the non-transitory computer-readable medium may be separate from the computer system 1000. In one example, the non-transitory computer-readable medium may be a removable medium provided to the input device(s) 1030 (as shown in FIG. 10), such as those described in reference to the input device(s) 1030, with the instructions 1003 being read into the computer system 1000 from the input device(s) 1030. In another example, the non-transitory computer-readable medium may be a component of a remote electronic device, such as a mobile phone, that may wirelessly transmit a data signal that carries the instructions 1003 to the computer system 1000 and that is received by the communications subsystem 1010 (as shown in FIG. 10).

The instructions 1003 may take any suitable form to be read and/or executed by the computer system 1000. For example, the instructions 1003 may be source code (written in a human-readable programming language such as Java, C, C++, C#, Python), object code, assembly language, machine code, microcode, executable code, and/or the like. In one example, the instructions 1003 are provided to the computer system 1000 in the form of source code, and a compiler is used to translate the instructions 1003 from source code to machine code, which may then be read into the main memory for execution by the processor(s) 1004.

As another example, instructions 1003 are provided to the computer system 1000 in the form of an executable file with machine code that may immediately be read into the main memory for execution by processor(s) 1004. In various examples, the instructions 1003 may be provided to the computer system 1000 in encrypted or unencrypted form, compressed or uncompressed form, as an installation package or an initialization for a broader software deployment, among other possibilities.

In one aspect of the present disclosure, a system (e.g., the computer system 1000) is provided to perform methods in accordance with various embodiments of the present disclosure. For example, some embodiments may include a system comprising at least one processor (e.g., the processor(s) 1004) that are communicatively coupled to a non-transitory computer-readable medium (e.g., the storage 1001). The non-transitory computer-readable medium may have instructions (e.g., the instructions 1003) stored thereon that, when executed by the at least one processor, cause the at least one processor to perform the methods or aspects thereof as described in the various embodiments.

In another aspect of the present disclosure, a computer-program product that includes instructions (e.g., instructions 1003) is provided to perform methods in accordance with various embodiments of the present disclosure. The computer-program product may be tangibly embodied in a non-transitory computer-readable medium (e.g., the storage 1001). The instructions may be configured to cause at least one processor (e.g., the processor(s) 1004) to perform the methods or aspects thereof as described in the various embodiments.

In another aspect of the present disclosure, a non-transitory computer-readable medium (e.g., the storage 1001) is provided. The non-transitory computer-readable medium may have instructions (e.g., instructions 1003) stored thereon that, when executed by at least one processor (e.g., processor(s) 1004), cause the at least one processor to perform the methods or aspects thereof as described in the various embodiments.

By providing an ancestor-identification system, method, and/or computer-program product, the problem of unknown individuals in images, such as family pictures, being difficult to research and thereby become acquainted with through family history research, is advantageously addressed. In embodiments of the disclosure, a specialized database is provided for identifying unknown persons in images and linking them to known individuals in a genealogical tree and/or ancestor-recognition cluster database along with associated records, images, and relationships. This facilitates connections between a user and long-lost relatives, unblocks challenging family history research, and results in greater emotional engagement with a family history modality.

It is to be understood that not necessarily all objects or advantages may be achieved under any embodiment of the disclosure. Those skilled in the art will recognize that the ancestor-identification system, computer program product, and/or method embodiments may be embodied or carried out, so they achieve or optimize one advantage or group of advantages as taught herein without necessarily achieving other objects or advantages as taught or suggested herein.

The skilled artisan will recognize the interchangeability of various disclosed features. Besides the variations described, other known equivalents for each feature can be mixed and matched by one of skill in this art to provide or utilize an ancestor-identification system, computer program product, and/or method under principles of the present disclosure. It will be understood by the skilled artisan that the features described may apply to other types of data, contexts, and/or models.

Although this disclosure describes certain exemplary embodiments and examples of an ancestor-identification system, computer program product, and/or method, it nevertheless will be understood by those skilled in the art that the present disclosure extends beyond the specifically disclosed embodiments to other alternative embodiments and/or uses of the disclosure and obvious modifications and equivalents thereof. It is intended that the scope of the present disclosure should not be limited by the particular disclosed embodiments described above, and may be extended to other uses, approaches, and contexts of family tree-, genealogy-, and/or genetic-related applications.

FIG. 11 is a schematic diagram illustrating environment 1100 within which one or more implementations of the ancestor-identification system 102 can be implemented. For example, the ancestor-identification system 102 may be part of a genealogical data system 1102 (e.g., the genealogical data system 1102). The genealogical data system 1102 may generate, store, manage, receive, and send digital content (such as genealogical content items). For example, genealogical data system 1102 may send and receive digital content to and from client devices 1106 by way of network 1104. In particular, genealogical data system 1102 can store and manage genealogical databases for various user accounts, historical records, and genealogy trees. In some embodiments, the genealogical data system 1102 can manage the distribution and sharing of digital content between computing devices associated with user accounts. For instance, the genealogical data system 1102 can facilitate a user account sharing a genealogical content item with another user account of genealogical data system 1102.

In particular, the genealogical data system 1102 can manage synchronizing digital content across multiple client devices 1106 associated with one or more user accounts. For example, a user may edit a digitized historical document or a node within a genealogy tree using client device 1106. The genealogical data system 1102 can cause client device 1106 to send the edited genealogical content to the genealogical data system 1102, whereupon the genealogical data system 1102 synchronizes the genealogical content on one or more additional computing devices.

As shown, the client device 1106 may be a desktop computer, a laptop computer, a tablet computer, an augmented reality device, a virtual reality device, a personal digital assistant (PDA), an in- or out-of-car navigation system, a handheld device, a smart phone or other cellular or mobile phone, or a mobile gaming device, other mobile device, or other suitable computing devices. The client device 1106 may execute one or more client applications, such as a web browser (e.g., Microsoft Windows Internet Explorer, Mozilla Firefox, Apple Safari, Google Chrome, Opera, etc.) or a native or special-purpose client application (e.g., Ancestry: Family History & DNA for iPhone or iPad, Ancestry: Family History & DNA for Android, etc.), to access and view content over the network 1104.

The network 1104 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1106 may access genealogical data system 1102.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method, comprising:
segmenting a source digital image to detect a target face depicted in the source digital image;
determining, based on segmenting the source digital image and by analyzing a face-image index comprising a plurality of digital images depicting faces of individuals, a matching digital image depicting a face within a threshold similarity of the target face depicted in the source digital image;
determining, based on analyzing the face-image index, that the target face depicted in the source digital image corresponds to a deceased individual;
identifying, based on the matching digital image and from an ancestor-recognition cluster database comprising clusters of data records corresponding to respective individuals, a matching cluster corresponding to the deceased individual depicted in the matching digital image;
modifying the ancestor-recognition cluster database by updating edges within the matching cluster to reflect relationships impacted by the source digital image of the deceased individual; and
generating, for display on a client device, a face-match notification indicating the deceased individual from the matching cluster.

2. The computer-implemented method of claim 1, further comprising determining that the target face depicted in the source digital image corresponds to the deceased individual by determining a nonliving score for the deceased individual from a plurality of nodes of a tree database.

3. The computer-implemented method of claim 2, wherein generating the face-match notification comprises generating, for display on the client device, an indication of a genealogy tree including the deceased individual from the matching cluster.

4. The computer-implemented method of claim 3, further comprising generating a path of the genealogy tree linking a first node corresponding to a user account associated with the client device and a second node corresponding to the deceased individual of the matching cluster.

5. The computer-implemented method of claim 1, further comprising:
identifying, from the face-image index, an additional digital image corresponding to the target face depicted in the source digital image;
providing, for display on the client device, a notification of the additional digital image; and
receiving, from the client device, a confirmation verifying a match for at the additional digital image.

6. The computer-implemented method of claim 1, further comprising modifying, based on identifying the matching cluster for the target face depicted in the source digital image, a genealogy tree of a user account associated with the client device to include the source digital image.

7. The computer-implemented method of claim 1, further comprising:
identifying an additional face depicted in the source digital image;
determining, by analyzing the face-image index, an additional matching digital image depicting a face of an additional individual that corresponds to the additional face;
identifying, by analyzing the ancestor-recognition cluster database using the additional matching digital image, an additional matching cluster corresponding to the additional individual depicted in the source digital image; and
labeling the additional individual within the source digital image to render the source digital image searchable by user accounts linked to the additional individual.

8. A system comprising:
one or more memory devices; and
at least one processor coupled to the one or more memory devices, wherein the at least one processor is configured to cause the system to:
receive a source digital image from a client device associated with a user account;
segment the source digital image to detect a target face depicted in the source digital image;
determine, based on segmenting the source digital image and by analyzing a face-image index comprising a plurality of digital images depicting faces of individuals, a matching digital image depicting a face within a threshold similarity of the target face depicted in the source digital image;
determine, based on analyzing the face-image index, that the target face depicted in the source digital image corresponds to a deceased individual;
identify, based on the matching digital image and from an ancestor-recognition cluster database comprising clusters of data records corresponding to respective individuals, a matching cluster corresponding to the deceased individual depicted in the matching digital image;
modify the ancestor-recognition cluster database by updating edges within the matching cluster to reflect relationships impacted by the source digital image of the deceased individual; and
generate, for display on the client device, a face-match notification indicating the deceased individual from the matching cluster.

9. The system of claim 8, wherein the at least one processor is further configured to determine that the target face depicted in the source digital image corresponds to the deceased individual by determining a nonliving score for the deceased individual from a plurality of nodes of a tree database.

10. The system of claim 8, wherein the at least one processor is further configured to generate the face-match notification by generating, for display on the client device, an indication of a genealogy tree including the deceased individual from the matching cluster.

11. The system of claim 10, wherein the at least one processor is further configured to generate a path of a genealogy tree linking a first node corresponding to a user account associated with the client device and a second node corresponding to the deceased individual of the matching cluster.

12. The system of claim 8, wherein the at least one processor is further configured to:
identify, from the face-image index, an additional digital image corresponding to the target face depicted in the source digital image;
provide, for display on the client device, a notification of the additional digital image; and
receive, from, the client device, a confirmation verifying a match for the additional digital image.

13. The system of claim 8, wherein the at least one processor is further configured to modify, based on identifying the matching cluster for the target face depicted in the source digital image, a genealogy tree of a user account associated with the client device to include the source digital image.

14. The system of claim 8, wherein the at least one processor is further configured to:
identify an additional face depicted in the source digital image;
determine, by analyzing the face-image index, an additional matching digital image depicting a face of an additional individual that corresponds to the additional face;
identify, by analyzing the ancestor-recognition cluster database using the additional matching digital image, an additional matching cluster corresponding to the additional individual depicted in the source digital image; and
label the additional individual within the source digital image to render the source digital image searchable by user accounts linked to the additional individual.

15. A non-transitory computer-readable medium storing instructions which, when executed by at least one processor, cause the at least one processor to:
segment a source digital image to detect a target face depicted in the source digital image;
determine, based on segmenting the source digital image and by analyzing a face-image index comprising a plurality of digital images depicting faces of individuals, a matching digital image depicting a face within a threshold similarity of the target face depicted in the source digital image;
determine, based on analyzing the face-image index, that the target face depicted in the source digital image corresponds to a deceased individual;
identify, based on the matching digital image and from an ancestor-recognition cluster database comprising clusters of data records corresponding to respective individuals, a matching cluster corresponding to the deceased individual depicted in the matching digital image;
modify the ancestor-recognition cluster database based on identifying the matching cluster by updating edges within the matching cluster to reflect relationships impacted by the source digital image of the deceased individual; and
generate, for display on a client device, a face-match notification indicating the deceased individual from the matching cluster.

16. The non-transitory computer-readable medium of claim 15, further comprising instructions that, when executed by the at least one processor, cause the at least one processor to determine that the target face depicted in the source digital image corresponds to the deceased individual by determining a nonliving score for the deceased individual from a plurality of nodes of a tree database.

17. The non-transitory computer-readable medium of claim 15, further comprising instructions that, when executed by the at least one processor, cause the at least one processor to generate the face-match notification by generating, for display on the client device, an indication of a genealogy tree including the deceased individual from the matching cluster.

18. The non-transitory computer-readable medium of claim 17, further comprising instructions that, when executed by the at least one processor, cause the at least one processor to generate a path of a genealogy tree linking a first node corresponding to a user account associated with the client device and a second node corresponding to the deceased individual of the matching cluster.

19. The non-transitory computer-readable medium of claim 15, further comprising instructions that, when executed by the at least one processor, cause the at least one processor to:
identify, from the face-image index, an additional digital image corresponding to the target face depicted in the source digital image;
provide for display on the client device, a notification of the additional digital image; and
receive, from the client device, a confirmation verifying a match for the additional digital image.

20. The non-transitory computer-readable medium of claim 15, further comprising instructions that, when executed by the at least one processor, cause the at least one processor to modify, based on identifying the matching cluster for the target face depicted in the source digital image, a genealogy tree of a user account associated with the client device to include the source digital image.
